(19) United States
(12) Patent Application Publication
(10) Pub. No.: US 2001/0035964 A1
(43) Pub. Date: Nov. 1, 2001

(54) Tape cartridge, tape printing method, tape printing apparatus, and label-producing method

(76) Inventor: Hiroyasu Kurashina, Matsumoto-shi (JP)

Correspondence Address: HOGAN & HARTSON L.L.P., 500 S. GRAND AVENUE, SUITE 1900, LOS ANGELES, CA, 90071-2611, US

(21) Appl. No.: 09/826,408

(22) Filed: Apr. 3, 2001

(30) Foreign Application Priority Data
Apr. 20, 2000 (JP) 2000-119223
Apr. 20, 2000 (JP) 2000-119224

(51) Int. Cl. B41B 1/00

(52) U.S. Cl. 358/1.1

(57) ABSTRACT

There are provided provide a tape printing method and apparatus which enables an arbitrary tape cartridge to hold desired configuration information in a detectable manner, and a tape cartridge holding the desired configuration information as well as a label-producing method capable of producing a label printed with a print image based on the desired configuration information. Further, there are provided a tape cartridge holding information of an image of a fixed-form character string to be printed, in a detectable manner, and a tape printing method and apparatus which are capable of printing the fixed-form character string image on a tape dispensed from the tape cartridge without newly inputting the fixed-form character string, as well as a label-producing method which is capable of producing a label printed with the fixed-form character string image. A to-be-detected image representative of the desired configuration information is printed on a first tape accommodated in a first tape cartridge such that the to-be-detected image can be detected by a predetermined detection device, where by a detection label for being labeled on an arbitrary tape cartridge is produced with the to-be-detected image printed on the label. A tape cartridge bears the to-be-detected image such that it can be detected by a predetermined detection device. The to-be-detected image is a character string information image that represents character string information for printing an image of a fixed-form character string having at least one character arranged therein.

### BACKGROUND OF THE INVENTION

1. Field of the Invention

This invention relates to a tape cartridge, a tape printing method, a tape printing apparatus, and a label-producing method.

2. Prior Art

Conventionally, a tape printing apparatus has been proposed which is capable of accommodating any of several types of tape cartridges containing respective types of tapes, determining the type of a tape cartridge (e.g. width and material of a tape contained therein), printing on the tape a character string image having one or more desired characters, such as letters, symbols, numerals and figures, (hereinafter generically referred to as “characters”) such that the character string image is adjusted to the type of the tape cartridge, cutting off a printed portion of the tape to a predetermined or desired length, to thereby produce a label.

In the conventional tape printing apparatus of the above-mentioned kind, it is possible to obtain information (for instance, the maximum count of lines to be input, required print energy, amount of ink, etc.) related to physical properties of a tape cartridge mounted therein, but it is originally impossible to obtain information of typefaces, such as Times New Roman and Courier New, or decorations, such as hollowing, italicizing, emphasizing, etc., that is, information (desired configuration information) which the user can set as he desires. In other words, it is impossible to cause an arbitrary tape cartridge to hold desired configuration information in a detectable manner. Even if an arbitrary tape cartridge can be stored, for instance, as a dedicated tape cartridge for printing in Times New Roman/italic, in a manner distinguished from another by writing a mark or the like on a surface thereof, it is impossible to print a print image, such as a character string image, in Times New Roman and italic based on the information held thereon, only by mounting the tape cartridge in the apparatus, without newly setting the information of a typeface and decoration to the tape printing apparatus.

Further, in the conventional tape printing apparatus of this kind, when a character string is printed, even if the character string is of a fixed-form type e.g. for a stylized message or the like, it is required in the first place to input the character string as text data. Also, even when the input fixed-form character string is registered or stored in the apparatus, it is necessary to read it out before printing. Furthermore, when several types of fixed-form character strings are registered, it is required to select a desired one from them before printing. Moreover, even if a fixed-form character string to be printed is determined in advance on a cartridge-by-cartridge basis, it is required to input, read, and select the fixed-form character string after replacement of tape cartridges.

That is, although it is possible to distinguish a predetermined tape cartridge from another e.g. by writing a mark or the like on a surface thereof, and storing the same as a dedicated tape cartridge for printing a predetermined fixed-form character string image, it is impossible to print the predetermined fixed-form character string image simply by mounting the tape cartridge without newly inputting the character string. In other words, there have not been provided a tape cartridge which enables printing of a predetermined fixed-form character string image without newly inputting the fixed-form character string thereof.

### SUMMARY OF THE INVENTION

It is a first object of the invention to provide a tape printing apparatus which enables an arbitrary tape cartridge to hold desired configuration information in a detectable manner, and a tape cartridge holding the desired configuration information, as well as a label-producing method which is capable of producing a label on which is printed a print image based on the desired configuration information by using the tape printing apparatus and the tape cartridge.

It is a second object of the invention to provide a tape cartridge holding information of an image of a fixed-form character string to be printed, in a detectable manner, and a tape printing method and apparatus which are capable of printing the fixed-form character string image on a tape dispensed from the tape cartridge simply by mounting the tape cartridge in the tape printing apparatus, without newly inputting the fixed-form character string, as well as a label-producing method which is capable of producing a label printed with the fixed-form character string image by the tape printing method and apparatus.

To attain the first object, according to a first aspect of the invention, there is provided a tape printing apparatus comprising:

first tape cartridge-mounting means for mounting a first tape cartridge accommodating a first tape;

desired configuration information input means for inputting desired configuration information; and

to-be-detected image-printing means for printing a to-be-detected image representative of the desired configuration information on the first tape such that the to-be-detected image can be detected by predetermined detection means, thereby enabling production of a detection label for being labeled on an arbitrary tape cartridge, with the to-be-detected image printed on the detection label.

According to this tape printing apparatus, a first tape cartridge accommodating a first tape is mounted, and desired configuration information is input. Then, in order to produce a detection label which is printed with an image detectable by predetermined detection means, for being labeled on an arbitrary tape cartridge, the to-be-detected image representative of the desired configuration information is printed on the first tape such that the to-be-detected image can be detected by the detection means. Then, a portion including the to-be-detected image is cut off from the first tape to produce the detection label, and the produced detection label is labeled on the arbitrary tape cartridge. Thus, it becomes possible to cause the desired tape cartridge to hold the desired configuration information in a detectable manner. It should be noted that in the above case, for instance, the detection means may be implemented by optical sensor means (light detection means) which is capable of optically reading (detecting) the to-be-detected image. Further, if the first tape is made e.g. of a thermoplastic material and can be formed with an embossed image through thermal printing, the detection means may be of a type for detecting the embossed pattern of the image. The former may include a photocoupler which is capable of the optical sensing if the to-be-detected image is an image formed e.g. by a bar code pattern, and light detection means which can detect an image itself similarly to a scanner. The latter includes mechanical detection means which can detect the embossed pattern of an embossed image by using detection switches of a push type which are turned on and off according to the embossed pattern.

Preferably, the desired configuration information contains information of designation of at least one of a typeface, a decoration, and a color, for use in printing.

According to this preferred embodiment, the desired configuration information contains information of designation of at least one of a typeface, a decoration, and a color, for use in printing, so that it is possible to print a to-be-detected image representative of the designation information on the first tape such that the to-be-detected image can be detected. Therefore, if a portion including the to-be-detected image is cut off from the tape to produce a detection label, and the detection label is labeled on an arbitrary tape cartridge, it is possible to cause the tape cartridge to detectably hold the desired configuration information.

Preferably, the to-be-detected image is an image of a pattern formed by patterning the desired configuration information in a predetermined format.

According to this preferred embodiment, the to-be-detected image is a pattern image formed by patterning the desired configuration information in a predetermined format, and the pattern image is printed on the first tape in a manner such that it can be detected. Hence, if a portion including the pattern image is cut off from the first tape to produce a detection label, and the detection label is labeled on an arbitrary tape cartridge, it is possible to cause the tape cartridge to hold the pattern image as desired configuration information detectable by the pattern of the image.

More preferably, the pattern represents a code formed by encoding the desired configuration information.

According to this preferred embodiment, the pattern of the pattern image represents a code formed by encoding the desired configuration information, and the pattern image is printed on the first tape such that it can be detected. Hence, if a portion including the pattern image is cut off from the tape to make a detection label, and the detection label is labeled on an arbitrary tape cartridge, it is possible to cause the tape cartridge to hold the pattern image as desired configuration information detectable as a code represented by the pattern of the pattern image.

Further preferably, the code is a binary code.

According to this preferred embodiment, the code represented by the pattern of the pattern image is a binary code, and the pattern image is printed on the first tape. Hence, if a portion including the pattern image is cut off to label the same on an arbitrary tape cartridge, it is possible to cause the tape cartridge to hold the pattern image as desired configuration information detectable as a binary code.

Further preferably, the pattern image is a unicolor pattern image that represents the code in a single color.

According to this preferred embodiment, since the code represented by the pattern of the pattern image is a binary code, and the pattern image is a unicolor pattern image representing the code in a single color, it is possible to carry out unicolor or monochrome printing. This makes it possible to reduce costs for causing the tape cartridge to hold desired configuration information. Further, in this case, the unicolor pattern may include not only a binary code represented by the presence or absence of a single color but also a multiple-valued pattern, such as a bar code represented by the lengths and widths of bars.

To attain the first object, according to a second aspect of the invention, there is provided a tape cartridge labeled with a detection label printed with a to-be-detected image representative of desired configuration information for use in printing.

According to this tape cartridge, it bears a detection label printed with a to-be-detected image representative of desired configuration information for use in printing, and therefore, by allowing a predetermined tape printing apparatus to read the desired configuration information, it is possible to print on a tape dispensed or unwound from the tape cartridge based on the desired configuration information e.g. in a specific type face and color without newly inputting the information.

Preferably, the detection label is formed by cutting off a first tape, the tape cartridge accommodating a second tape.

Preferably, the to-be-detected image is printed on the first tape by using a tape printing apparatus comprising:

first tape cartridge mounting means for mounting a first tape cartridge accommodating the first tape;

desired configuration information input means for inputting the desired configuration information; and

to-be-detected image-printing means for printing the to-be-detected image representative of the desired configuration information on the first tape such that the to-be-detected image can be detected by predetermined detection means.

According to this preferred embodiment, the tape cartridge accommodates the second tape and at the same time has the detection label labeled thereon which is produced by cutting off the portion of the first tape, which includes the to-be-detected image. Hence, the tape cartridge not only contains a tape but also holds desired configuration information input by the tape printing apparatus as the to-be-detected image printed on the detection label labeled thereon.

Preferably, the tape cartridge accommodates the first tape as the second tape, and can be mounted in the tape printing apparatus as the first tape cartridge.

According to this preferred embodiment, the tape cartridge is capable of accommodating the first tape as the second tape, and can be mounted in the tape printing apparatus as the first tape cartridge. Hence, the tape cartridge holds desired configuration information as a detection label labeled thereon, and at the same time it can be mounted in the tape printing apparatus for use in printing on the first tape to have the to-be-detected image newly printed on the second tape (first tape) accommodated therein. By cutting off the printed portion of the second tape (first tape), it is possible to produce a new detection label for causing another arbitrary tape cartridge to hold the desired configuration information.

To attain the first object, according to a third aspect of the invention, there is provided a tape printing apparatus comprising:

tape cartridge-mounting means for mounting a tape cartridge labeled with a detection label formed by cutting off a first tape printed with a to-be-detected image representative of desired configuration information for use in printing;

detection means for detecting the to-be-detected image which is printed on the detection label labeled on the tape cartridge; and

image-printing means for printing an image on the second tape based on the desired configuration information represented by the to-be-detected image.

According to this tape printing apparatus, the tape cartridge accommodating the second tape is mounted as a second tape cartridge in the tape printing apparatus and the to-be-detected image which is printed on the detection label affixed to the second cartridge is detected. Then, based on the detected image, the print image is printed on the second tape unwound from the second tape cartridge. That is, simply by mounting the second tape cartridge, the print image can be printed on the second tape based on the to-be-detected image printed on the detection label without newly setting the desired configuration information. It should be noted that the tape printing apparatus may dispense with the function of setting desired configuration information.

Preferably, the tape printing apparatus further includes character string input means for inputting a character string having at least one character arranged therein,

the desired configuration information represented by the to-be-detected image including information concerning printing of the input character string, and

the image printing means printing the print image based on the input character string according to the desired configuration information.

According to this preferred embodiment, data of the character string can be input, and the desired configuration information represented by the to-be-detected image includes information concerning printing of the character string image. The print image is a character image that is printed according to the desired configuration information and based on the data of the character string. Therefore, simply by inputting the data of the character string, it is possible to print the character string image according to the desired configuration information represented by the to-be-detected image, without newly setting the printing information of the character string image.

For instance, the print image is an image identical to the to-be-detected image.

According to this preferred embodiment, the print image is an image identical to the to-be-detected image, and if only the second tape cartridge is mounted in the tape printing apparatus, a to-be-detected image identical to the to-be-detected image can be printed on the second tape based on the to-be-detected image even if the desired configuration information is not newly set or even if the information cannot be newly set. Then, by cutting off the printed portion of the second tape, it is possible to produce a new detection label for causing an arbitrary tape cartridge other than the tape cartridge mounted as the second tape cartridge to hold the desired configuration information. Therefore, by using this tape printing apparatus for printing on the second tape, it is possible to produce one detection label after another which is printed with the to-be-detected image representative of the same desired configuration information, and by labeling each detection label to one desired tape cartridge after another, it is possible to cause the tape cartridges to hold the same desired configuration information, one after another. It should be noted that in this case, the tape printing apparatus may be of a type which detects a to-be-detected image for printing without further processing, or may be of a type which decodes the desired configuration information once, and then forms another to-be-detected image according to the desired configuration information for printing.

To attain the first object, according to a fourth aspect of the invention, there is provided a label-producing method comprising the steps of:

mounting a first tape cartridge accommodating a first tape in a first tape printing apparatus;

inputting desired configuration information to the first tape printing apparatus;

printing a to-be-detected image representative of the desired configuration information on the first tape by using the first tape printing apparatus such that the to-be-detected image can be detected by predetermined detection means;

producing a detection label by cutting off a portion including the to-be-detected image from the first tape;

labeling the detection label on a second tape cartridge accommodating a second tape;

mounting the second tape cartridge in a second tape printing apparatus including the predetermined detection means;

detecting the to-be-detected image which is printed on the detection label labeled on the second tape cartridge, by the predetermined detection means of the second tape printing apparatus;

printing a print image on the second tape dispensed from the second tape cartridge based on the desired configuration information represented by the to-be-detected image; and

producing a print image label by cutting off a portion including the print image from the second tape.

According to this label-producing method, first, the first tape cartridge accommodating the first tape is mounted in the first tape printing apparatus, and desired configuration information is input. Then, a to-be-detected image representative of the desired configuration information is printed on the first tape such that the to-be-detected image can be detected by a predetermined detection means, and a portion including the to-be-detected image is cut off from the first tape to produce a detection label. Thus, simply by labeling the detection label to an arbitrary tape cartridge, it is possible to cause the desired tape cartridge to detectably hold the desired configuration information. Therefore, next, in this label-producing method, the detection label is labeled to the second tape cartridge containing the second tape. This makes it possible to cause the second tape cartridge to detectably hold the desired configuration information. Further, in this label-producing method, then, the second tape cartridge is mounted in the second tape printing apparatus, having the detection means, and the to-be-detected image which is printed on the detection label affixed to the second cartridge is detected. Then, based on the detected image, a print image is printed on the second tape dispensed from the second tape cartridge, and a portion including the print image is cut off from the second tape, whereby the print image label is produced. In other words, in the second tape printing apparatus, simply by mounting the second tape cartridge, a print image can be printed on the second tape based on the to-be-detected image printed on the detection label without newly setting the desired configuration information, and by cutting off the printed portion, it is possible to produce the print image label.

It should be noted that in the above case, the first tape printing apparatus is only required to have a minimum function of setting desired configuration information, and printing a to-be-detected image representative of the desired configuration information. The second tape printing apparatus is only required to have a minimum function of detecting a to-be-detected image, and printing a print image, and accordingly the second tape printing apparatus may be one which does not have a function of setting desired configuration information. Therefore, the first tape printing apparatus and the second tape printing apparatus can be configured as different apparatuses from each other such that they are useable for different purposes. It should be noted that the detection means may be implemented by optical sensor means (light detection means), and if the first tape printing apparatus which is capable of forming an embossed image as a to-be-detected image, the detection means may be implemented by sensor means which is capable of detecting an embossed pattern of the embossed image.

Preferably, the first tape printing apparatus and the second tape printing apparatus are an identical tape printing apparatus.

According to this preferred embodiment, the first tape printing apparatus and the second tape printing apparatus are an identical tape printing apparatus. Therefore, setting of desired configuration information, printing of to-be-detected images, detection of to-be-detected images, and printing of print images can be carried out by one tape printing apparatus.

Preferably, the first tape cartridge and the second tape cartridge are an identical tape cartridge.

According to this preferred embodiment, the first tape cartridge and the second tape cartridge are an identical tape cartridge. Therefore, if the detection label printed with the to-be-detected image is labeled on the tape cartridge which was used as the first tape cartridge in printing the to-be-detected image, the tape cartridge can be further employed in printing a print image other than the to-be-detected image.

Preferably, the desired configuration information contains information of designation of at least one of a typeface, a decoration, and a color, for use in printing.

According to this preferred embodiment, the desired configuration information includes information of designation of at least one of a typeface, a decoration and a color, for use in printing. This makes it possible to set the information as desired configuration information, print a to-be-detected image representative of the desired configuration information, and produce a detection label printed with the to-be-detected image. And, by labeling the detection label to a tape cartridge, it is possible to cause the second tape cartridge to hold the desired configuration information. Further, if the to-be-detected image is detected, a print image can be printed based on the detected image thereby making it possible to produce a print image label printed with the print image.

Preferably, the to-be-detected image is an image of a pattern formed by patterning the desired configuration information in a predetermined format.

According to this preferred embodiment, the to-be-detected image is a pattern image formed by patterning the desired configuration information in a predetermined format, and the pattern image is printed on the first tape in a manner such that it can be detected. Hence, if a portion of the first tape including the pattern image is cut off to produce a detection label, and the detection label is labeled on an arbitrary tape cartridge, it is possible to cause the tape cartridge to hold the pattern image as desired configuration information detectable by the pattern thereof Further, by detecting the pattern image as the to-be-detected image, it is possible to print the print image based on the pattern image, thereby producing a print image label printed with the print image.

More preferably, the pattern represents a code formed by encoding the desired configuration information.

According to this preferred embodiment, the pattern of the pattern image is a pattern representative of a code formed by encoding the desired configuration information, and the pattern image is printed on the first tape. Therefore, by cutting off the printed portion of the first tape to produce a detection label, and labeling the detection label to a second tape cartridge, it is possible to cause the second tape cartridge to hold the pattern image as desired configuration information detectable as a code represented by the pattern of the pattern image. Further, by detecting the pattern image, it is possible to print a print image based on the pattern image, thereby producing a print image label printed with the print image.

Further preferably, the code is a binary code.

According to this preferred embodiment, the code represented by the pattern of the pattern image is a binary code, and the pattern image is printed on the first tape. Therefore, by cutting off the printed portion of the first tape to produce a detection label, and labeling the detection label to the second tape cartridge, it is possible to cause the tape cartridge to hold the pattern image as desired configuration information detectable as a binary code. Further, by detecting the to-be-detected image as a binary code, it is possible to print a print image based on the to-be-detected image, there by producing a print image label.

Further preferably, the pattern image is a unicolor pattern image that represents the code in a single color.

According to this preferred embodiment, the pattern image is a unicolor pattern image representing the code in a single color, so that it is possible to carry out unicolor printing. This makes it possible to reduce costs for causing tape cartridges to hold desired configuration information. Further, in this case as well, the unicolor pattern may be not only a binary code but also a multiple-valued pattern.

Preferably, the label-producing method further includes the step of inputting a character string having at least one character arranged therein, to the second tape printing apparatus,

the desired configuration information represented by the to-be-detected image containing information concerning printing of the input character string,

the print image being printed according to the desired configuration information based on the input character string.

According to this preferred embodiment, a character string is input to the second tape printing apparatus, and the desired configuration information represented by the to-be-detected image contains information of printing of a character string image. Further, the print image is a character image to be printed according to the desired configuration information based on the data of the character string. Therefore, information concerning printing of the character string image is set as desired configuration information, the to-be-detected image representative of the desired configuration information is printed on the first tape, and a detection label produced by cutting off the printed portion of the first tape is labeled to the second tape cartridge, whereby it is possible to cause the second tape cartridge to hold the information concerning printing of the character string image as the desired configuration information. Further, the second tape printing apparatus detects the to-be-detected image, and hence only by inputting the data of the character string, it is possible to print the character string image according to the desired configuration information represented by the to-be-detected image, without newly setting the information concerning printing of the character string image, and produce a character string image label by cutting off the printed portion of the tape.

Preferably, the image is a second to-be-detected image which is an image identical to the to-be-detected image.

According to this preferred embodiment, the print image is a second to-be-detected image which is an image identical to the to-be-detected image, and if only the second tape cartridge is mounted in the second tape printing apparatus, the second to-be-detected image identical to the to-be-detected image can be printed on the second tape based on the to-be-detected image even if the desired configuration information is not newly set or even if the information cannot be newly set. Then, by cutting off the printed portion of the second tape, it is possible to produce a new detection label for causing an arbitrary tape cartridge other than the tape cartridge mounted as the second tape cartridge to hold the desired configuration information. Therefore, by using the second tape printing apparatus, it is possible to produce one detection label after another, which is printed with the to-be-detected image representative of the same desired configuration information, and by labeling each detection label to one desired tape cartridge after another, it is possible to cause the tape cartridges to hold the same desired configuration information, one after another. It should be noted that in this case, the second tape printing apparatus may be of a type which detects a to-be-detected image for printing without further processing, or may be of a type which decodes the desired configuration information once, and then forms another to-be-detected image according to the desired configuration information for printing.

Preferably, the label-producing method further comprises the steps of:

labeling a second detection label to a third tape cartridge accommodating a third tape, the second detection label being a print image label produced by cutting off a portion including the second to-be-detected image which is printed on the second tape by the second tape printing apparatus, from the second tape;

mounting the third tape cartridge in a third tape printing apparatus including the predetermined detection means;

detecting the second to-be-detected image which is printed on the second detection label labeled on the third tape cartridge, by using the predetermined detection means of the third tape printing apparatus;

printing a second print image which is different from the second to-be-detected image, on the third tape dispensed from the third tape cartridge, based on the desired configuration information represented by the second to-be-detected image; and

producing a second print image label by cutting off a portion including the second print image from the third tape.

According to this preferred embodiment, the second to-be-detected image is printed on the second tape by the second tape printing apparatus, and a portion including second to-be-detected image is cut off from the second tape to form a print image label. Then, the print image label is labeled to the third tape cartridge containing the third tape as a second detection label, and the third tape cartridge is mounted in the third tape printing apparatus. The third tape printing apparatus detects the second to-be-detected image which is printed on the second detection label affixed to the third tape cartridge. Then, based on the second to-be-detected image, the third tape printing apparatus prints a second print image which is an image different from the second to-be-detected image, on the third tape dispensed from the third tape cartridge, and cuts off a portion including the second print image from the third tape, thereby producing a second print image label. In other words, similarly to the second tape printing apparatus, the third tape printing apparatus in this case detects the to-be-detected image (second to-be-detected image) printed on the detection label (second detection label). However, differently from the second tape printing apparatus, the third tape printing apparatus prints a print image (second print image) different from the detected image. Thus, in the third tape printing apparatus, only by mounting the third tape cartridge therein without newly setting the desired configuration information, it is possible to print a second print image on the third tape based on the second to-be-detected image printed on the detection label. After the second print image has been printed, the printed portion of the third tape is cut off to produce a second print image label.

Further preferably, the label-producing method further includes the step of inputting a character string having at least one character arranged therein, to the third tape printing apparatus,

the desired configuration information represented by the second to-be-detected image containing information concerning printing of the input character string, and

the second print image being printed according to the desired configuration information based on the input character string.

According to this preferred embodiment, a character string is input to the third tape printing apparatus, and the desired configuration information represented by the second to-be-detected image contains information concerning printing of a character string image. Further, the second to-be-detected image is a character image to be printed according to the desired configuration information based on the data of the character string. Therefore, in the first tape printing apparatus, the printing information of the character string image is set as desired configuration information, the to-be-detected image representative of the desired configuration information is printed on the first tape, and a detection label produced by cutting off the printed portion of the first tape is labeled to the second tape cartridge. Further, in the second tape printing apparatus, the second to-be-detected image which is the same image as the to-be-detected image printed on the first tape is printed on the second tape, and a second detection label produced by cutting off the printed portion of the second tape is labeled to the third tape cartridge. Thus, it is possible to cause the second tape cartridge and the third tape cartridge to hold the information concerning printing of the character string image as the desired configuration information. Further, the third tape printing apparatus detects the second to-be-detected image, and hence only by inputting data of a character string, it is possible to print an image of the character string according to the desired configuration information represented by the to-be-detected image, without newly setting the information concerning printing of the character string image, and produce a character string image label by cutting off the printed portion of the tape.

Further, in the above case, the second tape printing apparatus is only required to have the minimum function of detecting a to-be-detected image, and printing a second to-be-detected image which is the same image as the detected image. The third tape printing apparatus is only required to have the minimum function of detecting a to-be-detected image (second to-be-detected image), and printing an image of a character string. Therefore, the second tape printing apparatus and the third tape printing apparatus can be configured as apparatuses of different types from each other such that they are usable for different purposes.

Further preferably, the second tape printing apparatus and the third tape printing apparatus are an identical printing apparatus.

According to this preferred embodiment, the second tape printing apparatus and the third tape printing apparatus are an identical tape printing apparatus. Therefore, based on detection of a to-be-detected image and by using a single tape printing apparatus, it is possible to print the same image (second to-be-detected image) as the detected image, and a second print image which is different from the detected image.

To attain the second object, according to a fifth aspect of the invention, there is provided a tape cartridge bearing a to-be-detected image in a manner such that the to-be-detected image can be detected by a predetermined detection means,

wherein the to-be-detected image is a character string information image that represents character string information for printing an image of a fixed-form character string having at least one character arranged therein.

According to this tape cartridge, the tape cartridge bears a to-be-detected image in a manner such that the same can be detected by predetermined detection means, and the to-be-detected image is a character string information image that indicates character string information for printing an image of a fixed-form character string having at least one character arranged therein. Therefore, if this tape cartridge is mounted in a tape printing apparatus capable of detecting the to-be-detected image, it is possible to print a fixed-form character string image based on character string information represented by the to-be-detected image (character string information image) without newly inputting the fixed-form character string. That is, the tape detectably holds the information of the fixed-form character string image to be printed. Further, it should be noted that in this case, for instance, detection means may be implemented by optical sensor means (light detection means) which is capable of optically reading (detecting) the to-be-detected image. Further, when an embossed image is formed as a to-be-detected image, detection means (embossed pattern detection means) for detecting the embossed pattern of the image may be used.

Preferably, the to-be-detected image is the image of the fixed-form character string.

According to this preferred embodiment, the to-be-detected image is the image of the fixed-form character string. More specifically, the to-be-detected image (character string information image) indicates the fixed-form character string image itself as character string information, and hence if this tape cartridge is mounted in a tape printing apparatus capable of detecting the to-be-detected image, the fixed-form character string image detected can be printed as it is by the tape printing apparatus. In this case, the detection means may be implemented by light detection means which can detect an image itself similarly to a scanner or the like, and if the to-be-detected images is an embossed image, the same may be implemented by detection means for detecting an embossed pattern of the image.

Preferably, the to-be-detected image is a designation image representative of designation of selection of one of registered fixed-form character string images.

According to this preferred embodiment, the to-be-detected image is a designation image which designates one of registered fixed-form character string images. Accordingly, if at least one fixed-form character string is registered beforehand in a tape printing apparatus which is capable of detecting the to-be-detected image, and this tape cartridge is mounted therein, the tape printing apparatus detects the to-be-detected image (designation image) designating one of the fixed-form character string images registered as character string information, and can print the designated fixed-form character string image based on the character string information (designation). It should be noted that in this case as well, light detection means or embossed pattern detection means can be employed as detection means depending on the to-be-detected image.

More preferably, the to-be-detected image is an image of a pattern which is formed by patterning the designation in a predetermined format.

According to this preferred embodiment, the to-be-detected image is a pattern image which is formed by patterning the designation of the fixed-form character string image in a predetermined format. Hence, if at least one fixed-form character string is registered beforehand in a tape printing apparatus which is capable of detecting the to-be-detected image (pattern image) printed on a detection label, and this tape cartridge is mounted therein, it is possible to designate one of the fixed-form character string images by the pattern image, and cause the tape printing apparatus to print the designated fixed-form character string image. In this case, if the to-be-detected image is an image formed e.g. by a bar code pattern, light detection or optical sensing can be carried out by a photocoupler, and if the pattern image is an embossed one, mechanical detection means which can detect embossed pattern of an image by detection switches of a push type which are turned on and off according to the embossed pattern.

Further preferably, the pattern represents a code formed by encoding information of the designation.

According to this preferred embodiment, a pattern of the to-be-detected image represents a code formed by encoding information of the designation of a fixed-form character string image. Therefore, if at least one fixed-form character string is registered beforehand in a tape printing apparatus which is capable of reading a code of the to-be-detected image (pattern image), and this tape cartridge is mounted therein, it is possible to designate one of the fixed-form character string images by the code, and cause the tape printing apparatus to print the designated fixed-form character string image.

Even more preferably, the code is a binary code.

According to this preferred embodiment, since the code of the pattern of the to-be-detected image is a binary code, the to-be-detected image can be held as a to-be-detected image (character string information image) detectable as a binary code.

Even more preferably, the pattern image is a unicolor pattern image that represents the code in a single color.

According to this preferred embodiment, since the pattern image is a unicolor pattern image representing the code in a single color, the to-be-detected image in this case can be printed in unicolor, thereby making it possible to reduce costs for causing tape cartridges to hold character string information image. Further, in this case, the unicolor pattern may be not only a binary code represented by the presence or absence of a single color but also a multiple-valued pattern, such as a bar code represented by the lengths and widths of bars.

Preferably, the to-be-detected image is printed or formed on a surface of a member attached to a cartridge casing.

According to this preferred embodiment, the to-be-detected image is an image printed or formed on a surface of a member attached to a surface of the cartridge casing. In other words, the member attached to a surface of the cartridge casing is printed or formed with the to-be-detected image, whereby information of a fixed-form character string image to be printed is held in a detectable manner. Therefore, if this tape cartridge is mounted in a tape printing apparatus which is capable of detecting the to-be-detected image on the member, it is possible to print a fixed-form character string image based on character string information represented by the to-be-detected image (character string information image) without newly inputting the fixed-form character string.

More preferably, the member attached to the cartridge casing is a label affixed to a surface of the cartridge casing.

According to this preferred embodiment, the member attached to the cartridge casing is a label labeled to a surface of the cartridge casing. That is, a detection label which is printed or formed with the to-be-detected image is labeled on the surface of the cartridge casing, whereby information of a fixed-form character string image to be printed is held in a detectable manner. Therefore, if this tape cartridge is mounted in a tape printing apparatus which is capable of detecting the to-be-detected image on the detection label, it is possible to print the fixed-form character string image based on the character string information represented by the to-be-detected image (character string information image).

More preferably, the member attached to the cartridge casing is a plate attached to a surface of the cartridge casing.

According to this preferred embodiment, the member attached to the cartridge casing is a plate attached to the surface of the cartridge casing. More specifically, a plate (detection plate) which is formed e.g. of a plastic or a cardboard is attached to the surface of the cartridge casing, and the plate is printed or formed with the to-be-detected image, whereby information of a fixed-form character string image to be printed is held in a detectable manner. Hence, if this tape cartridge is mounted in a tape printing apparatus which is capable of detecting the to-be-detected image, it is possible to print the fixed-form character string image based on character string information represented by the to-be-detected image.

Preferably, the to-be-detected image is an image printed or formed on a surface of the cartridge casing.

According to this preferred embodiment, the to-be-detected image is an image printed or formed on a surface of the cartridge casing, whereby information of a fixed-form character string image to be printed is held in a detectable manner. Hence, if this tape cartridge is mounted in a tape printing apparatus which is capable of detecting the to-be-detected image, it is possible to print the fixed-form character string image based on character string information represented by the to-be-detected image.

To attain the second object, according to a sixth aspect of the invention, there is provided a tape printing method comprising the steps of:

mounting a tape cartridge;

detecting a to-be-detected image that the tape cartridge bears; and

printing a fixed-form character string image based on character string information represented by the to-be-detected image.

To attain the second object, according to a seventh aspect of the invention, there is provided a tape printing apparatus comprising:

tape cartridge-mounting means for mounting a tape cartridge;

detection means for detecting a to-be-detected image that the tape cartridge bears; and

character string image-printing means for printing a fixed-form character string image on a tape dispensed from the tape cartridge, based on character string information represented by the to-be-detected image.

According to this tape printing method and apparatus, the tape cartridge is mounted, the to-be-detected image that the tape cartridge bears is detected, and the fixed-form character string image is printed on the tape dispensed or unwound from the tape cartridge, based on the character string information represented by the to-be-detected image. That is, simply by mounting the tape cartridge in the apparatus, without newly inputting the fixed-form character string, it is possible to print the fixed-form character string image on the tape dispensed or unwound from the tape cartridge based on the character string image represented by the to-be-detected image. It should be noted that in the case of the to-be-detected image being a fixed-form character string image (the case of the to-be-detected image being printed as it is), it is possible to omit (dispense with) input means (keyboard, for instance) for inputting character strings and the like. Further, also when the to-be-detected image is a designation image, if a fixed-form character string image is registered (stored: stored e.g. in the ROM for being mounted in the apparatus) in advance, the input means can be omitted (dispensed with) similarly.

Preferably, the tape printing method further includes the step of taking up a tape printed with the fixed-form character string image.

Preferably, the tape printing apparatus further includes tape take-up means for taking up a tape printed with the fixed-form character string image.

According to these preferred embodiments, since the tape printed with a fixed-form character string image is taken up, printing of the fixed-form character string image and taking up of the tape are repeated a plurality of times, thereby making it possible to obtain a tape on which the same fixed-form character string image is printed in succession a plurality of times. That is, it is possible to obtain a tape which permits labels printed with the same fixed-form character string image to be produced in succession simply by cutting off the fixed-form character string images one by one.

Preferably, the tape printing apparatus further includes tape cutter means for cutting off a portion printed with the fixed-form character string image from the tape.

According to this preferred embodiment, the portion printed with the fixed-form character string image is cut off by the cutter means, thereby making it possible to produce a label printed with the fixed-form character string image.

To attain the second object, according to an eighth aspect of the invention, there is provided a label-producing method comprising the steps of:

mounting a tape cartridge;

detecting a to-be-detected image that the tape cartridge bears;

printing a fixed-form character string image based on character string information represented by the to-be-detected image;

taking up a tape printed with the fixed-form character string image; and

cutting off a portion printed with the fixed-form character string image from the tape.

According to this label-producing method, a fixed-form character string image is printed on a tape by carrying out the above steps, and by cutting off a portion printed with the fixed-form character string image, it is possible to produce a label printed with the fixed-form character string image.

The above and other objects, features, and advantages of the invention will become more apparent from the following detailed description taken in conjunction with the accompanying drawings.

### BRIEF DESCRIPTION OF THE DRAWINGS

FIG. 1 is a perspective view of an appearance of a tape printing apparatus to which are applied a tape cartridge, a tape printing method, a tape printing apparatus, and a label-producing method, according to an embodiment of the present invention;

FIG. 2 is a perspective view showing the FIG. 1 tape printing apparatus with a lid thereof being open;

FIG. 3 is a block diagram schematically showing a control system of the FIG. 1 tape printing apparatus;

FIG. 4 is a flowchart showing a conceptual representation of an overall control process executed by the FIG. 1 tape printing apparatus;

FIG. 5A is a diagram showing a schematic representation of the tape printing apparatus according to the embodiment;

FIG. 5B is a diagram useful in explaining desired configuration information;

FIG. 6 is a diagram schematically illustrating examples of a display screen and an operating procedure carried out on the display screen, which is useful in explaining a pattern-setting process and pattern printing based on pattern settings;

FIGS. 7A and 7B are diagrams showing schematic representations of the tape printing apparatus, similarly to FIG. 5A, which are useful in explaining pattern printing carried out based on pattern settings;

FIG. 8 is a flowchart showing a printing process for carrying out text printing based on detection of patterns;

FIGS. 9A and 9B are diagrams similar to FIGS. 7A and 7B, which are useful in explaining text printing carried out based on detection of patterns;

FIG. 10 is a flowchart showing a pattern printing process for carrying out pattern printing based on detection of patterns;

FIGS. 11A and 11B are diagrams similar to FIGS. 7A and 7B, which are useful in explaining pattern printing carried out based on detection of patterns; and

FIG. 12 is a diagram useful in explaining variants of the invention.

### DETAILED DESCRIPTION

The invention will now be described in detail with reference to the drawings showing an embodiment thereof. In the embodiment, a tape cartridge, a tape printing method, a tape printing apparatus and a label-producing method according to the invention are applied to a tape printing apparatus.

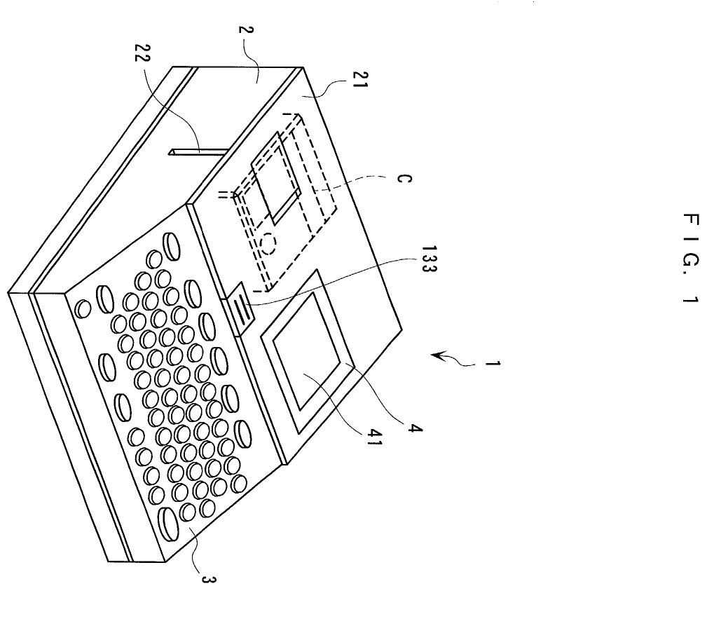

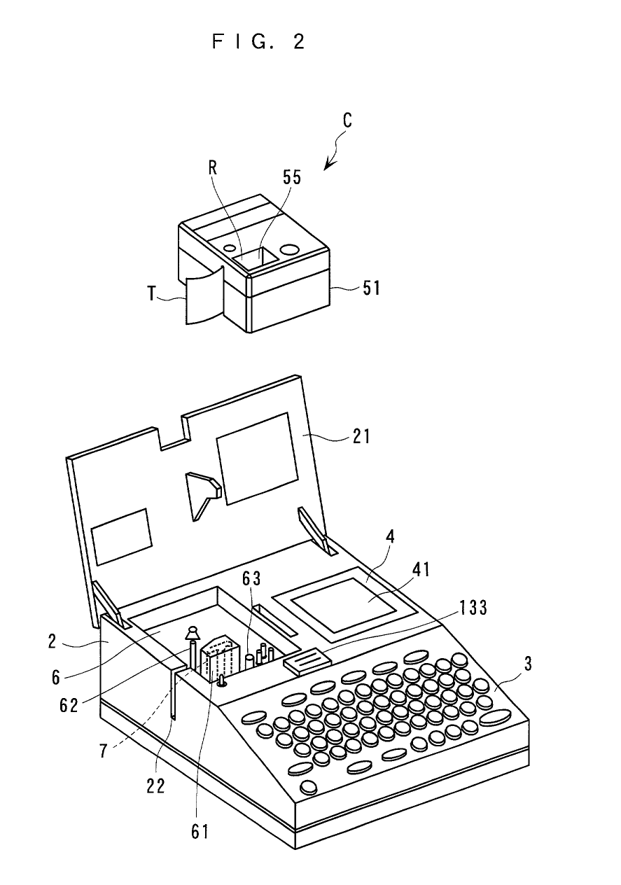

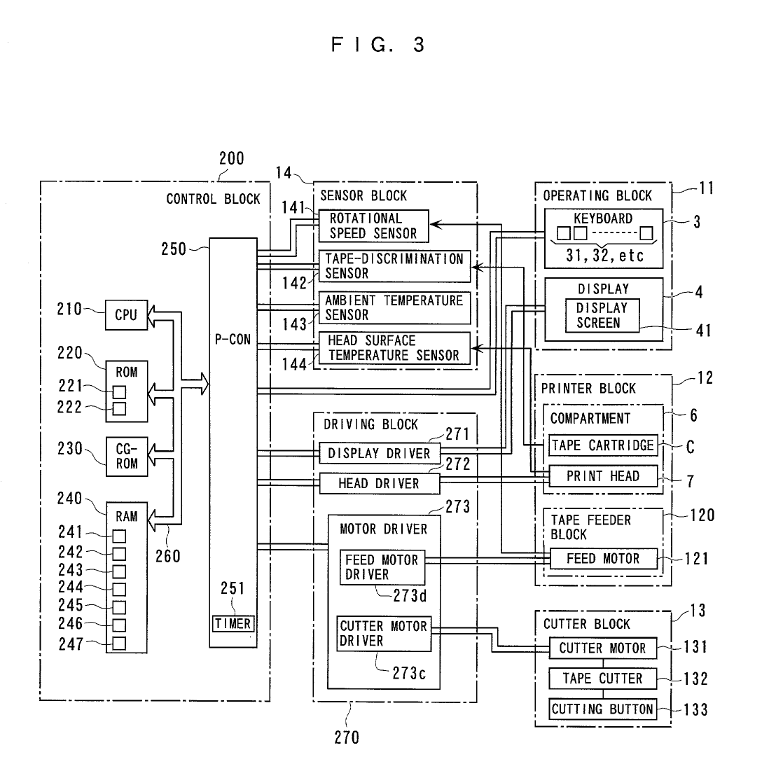

FIG. 1 is a perspective view of an appearance of the whole tape printing apparatus according to the present embodiment, and FIG. 2 is a perspective view of the FIG. 1 tape printing apparatus with its lid being open and a tape cartridge being removed therefrom. FIG. 3 is a block diagram schematically showing a control system of the FIG. 1 tape printing apparatus. As shown in FIGS. 1 and 2, the tape printing apparatus 1 includes a casing 2 having upper and lower divisional portions. The casing 2 has a keyboard 3, which is comprised of various kinds of entry keys, arranged on the top of the front portion thereof, a lid 21 attached to the top of the rear portion thereof, and a display 4 arranged to face a window formed in the right-hand side of the lid 21.

Further, as shown in FIG. 3, the tape printing apparatus 1 is basically comprised of an operating block 11 having the keyboard 3 and the display 4 for interfacing with the user, a printer block 12 having a print head (thermal head) 7 and a tape feeder block 120 for printing on a printing tape (hereinafter simply referred to as “the tape”) T unwound from a tape cartridge C mounted in a compartment 6, a cutter block 13 for cutting off a printed portion of the tape T, a sensor block 14 having various sensors for carrying out various detecting operations, a driving block 270 having drivers for driving circuits of devices of the apparatus 1, and a control block 200 for controlling operations of blocks and devices of the apparatus 1 including the above-mentioned sensors and drivers. To implement the above construction, the casing 2 accommodates a circuit board, not shown, in addition to the printer block 12, the cutter block 13, the sensor block 14 and so forth. On the circuit board are mounted a power supply unit and the circuits of the driving block 270 and the control block 200. The circuit board is connected to a connector port for connecting an AC adapter thereto, and batteries, such as nicad batteries, which can be removably mounted within the casing 2 from outside.

In the tape printing apparatus 1, after mounting the tape cartridge C in the compartment 6, the user enters printing information, such as desired characters (letters, numerals, symbols, simple figures, etc.) via the keyboard 3, while confirming or viewing the results of the entry or edit of the printing information on the display 4. Thereafter, when the user instructs the apparatus 1 to perform a printing operation via the keyboard 3, the tape feeder block 120 unwinds a tape T from the tape cartridge C, while the print head 7 prints on the tape T. The printed portion of the tape T is delivered from a tape exit 22 as the printing proceeds. When the desired printing operation is completed, the tape feeder block 120 sends the tape T to a position corresponding to an end of a tape length (the length of a label to be formed) including the length of margins, and then stops the feeding of the tape.

As shown in FIGS. 2 and 3, the printer block 12 has the compartment 6 arranged under the lid 21 for mounting the tape cartridge C therein. The tape cartridge C can be mounted in or removed from the compartment 6 when the lid 21 is open. The tape cartridge C has a cartridge casing 51 holding a tape T having a predetermined width (approximately 4.5 to 48 mm) and an ink ribbon R. The tape cartridge C is formed with a through hole 55 for receiving therein a head unit 61 arranged in the compartment 6. Further, the tape cartridge C has a plurality of small holes formed in the bottom thereof for discrimination of a type of the tape T contained therein from the other types of the tape T having different widths, which are contained in other types of tape cartridges C. To a side surface of the tape cartridge C is affixed a label (detection label) printed with a detection pattern, described hereinafter. The compartment 6 has a tape-discriminating sensor 142 including micro-switches (means for detecting an embossed pattern, i.e. projections or depressions thereof, or holes) for detecting the above holes and a photocoupler (light detection means) for reading the detection pattern, whereby the type of the tape T and desired configuration information can be detected.

The tape T has an adhesive surface on the reverse side which is covered with a peel-off paper. The tape T and the ink ribbon R are fed or run such that they pass by the through hole 55, in a state lying one upon the other, and the tape T alone is delivered out of the tape cartridge C, but the ink ribbon R is taken up into a roll within the tape cartridge C.

The head unit 61 contains the print head 7 formed of a thermal head. The print head 7 is brought into contact with the reverse side of the ink ribbon R exposed to the through hole 55 of the tape cartridge C when the tape cartridge C is mounted in the compartment 6 with the print head 7 fitted in the through hole 55. Then, by driving the print head 7 while heating the same, desired letters and the like are printed on the surface of the tape T. The compartment 6 is provided with an ambient temperature sensor 143, such as a thermistor, which sends information of an ambient temperature detected thereby to the control block 200. Further, the casing 2 has a left side portion thereof formed with the tape exit 22 for causing the compartment 6 and the outside of the apparatus to communicate with each other. Opposed to the tape exit 22, there is arranged a tape cutter 132 for cutting off a dispensed portion of the tape T. Further, the compartment 6 is provided with drive shafts 62, 63 for engagement with driven portions of the tape cartridge 4 mounted in the compartment 6. A feed motor 121 as a drive source drives these drive shafts 62, 63 for rotation to feed or advance the tape T and the ink ribbon R in the tape cartridge C, and at the same time the print head 7 is driven in synchronism with the feeding of the tape and ribbon to carry out printing. Further, after completion of the printing operation, the tape T continues to be fed to bring a predetermined cutting position (corresponding to the tape length) on the tape T to the position of the tape cutter 132.

It should be noted that a head surface temperature sensor 144 formed e.g. by a thermistor is arranged on a surface of the print head 7 in a manner intimately contacting the surface, which sends information of the surface temperature of the print head 7 detected thereby to the control block 200. The feedmotor 121 has an end on which is rigidly fitted a disc, not shown, formed with detection openings, and a rotational speed sensor 141 including a photo sensor or the like is provided to face the path of the detection openings, for sending information of the rotational speed of the feed motor 121 detected thereby to the control block 200.

The cutter block 13 includes a tape cutter 132, a cutting button 133 for being manually operated to cause the tape cutter 132 to cut the tape T when a desired length printing is carried out, for instance, and a cutter motor 131 for automatically driving the tape cutter 132 to cut the tape T when a fixed length printing is carried out, for instance. To selectively carry out one of the two cutting operations, the tape printing apparatus 1 is capable of being switched between a manual cutting mode and an automatic cutting mode according to a mode-setting operation. More specifically, in the manual cutting mode, when the printing operation is completed, the user pushes the cutting button 133 arranged on the casing 2, whereby the tape cutter 132 is actuated to cut the tape T to a desired length. On the other hand, in the automatic cutting mode, after completion of the printing operation, the tape T is sent for incremental feed by the length of a rear margin, and then stopped, whereupon the cutter motor 131 is driven to cut off the tape T.

The sensor block 14 includes the rotational speed sensor 141, the tape-discriminating sensor 142, the ambient temperature sensor 143 and the head surface temperature sensor 144. It should be noted that the above sensors can be omitted to suit the actual requirements of the tape printing apparatus.

The driving block 270 includes a display driver 271, a head driver 272, and a motor driver 273. The display driver 271 drives the display 4 of the operating block 11 in response to control signals delivered from the control block 200, i.e. in accordance with commands carried by the signals. Similarly, the head driver 272 drives the print head 7 of the printer block 12 in accordance with commands from the control block 200. Further, the motor driver 273 includes a feed motor driver 273d for driving the feed motor 121 of the printer block 12, and a cutter motor driver 273c for driving the cutter motor 131 of the cutter block 13, and similarly to the display driver 271 and the head driver 272, drives each motor in accordance with commands from the control block 200.

The operating block 11 includes the keyboard 3 and the display 4. The display 4 has a display screen 41 which is capable of displaying display image data of 96×64 dots on a rectangular display area of approximately 6 cm in the horizontal direction (X direction)×4 cm in the vertical direction (Y direction). The display 4 is used by the user when he enters data, instructions or commands via the keyboard 3 to form or edit print image data, such as character string image data (i.e. text print data, referred to hereinafter) and detection image data (i.e. pattern print data, referred to hereinafter), and check the result of the entry.

On the keyboard 3, there are arranged a character key group 31 including an alphabet key group, a symbol key group, a number key group, and a nonstandard character key group for calling nonstandard characters for selection, as well as a function key group 32 for designating various operation modes. In a type of the apparatus which is capable of inputting the Japanese language, there is also provided a kana key group for inputting Japanese hiragana letters and Japanese katakana letters.

The function key group 32 includes a power key, not shown, a print key, not shown, for instructing the apparatus 1 to perform a printing operation, a selection key, not shown, for finally determining entry of character data and feeding lines during text entry as well as determining selection of one of modes or options on a selection screen, a decoration-setting key, not shown, for setting a decoration, such as a so-called character decoration e.g. by hatching, underlining, boxing, etc. or a background decoration (including a background pattern, an illustration and the like), a color-setting key, not shown, for setting colors (including gray levels, color saturation, luster, transparency, and so forth) of characters, a background and a decoration, and four cursor keys (up arrow key 330U, down arrow key 330D, left arrow key 330L, and right arrow key 330R), not shown in FIG. 3, for moving the cursor or the display range of print image data on the display screen 41 in respective upward, downward, leftward, and rightward directions.

The function key group 32 also includes a cancel key, not shown, for canceling instructions, a shift key, not shown, for use in changing roles of respective keys as well as modifying registered image data, an image key, not shown, for alternately switching between a text entry screen or a selection screen and a display screen (image screen) for displaying print image data, a proportion-changing (zoom) key, not shown, for changing a proportion between the size of a print image and the size of a display image displayed on the image screen, a form key, not shown, for setting formats, including typefaces, a pattern-setting key, not shown, for forming a detection pattern, referred to hereinafter, (i.e. for setting desired configuration information), and a pattern print key, not shown, for printing a detected detection pattern again.

Similarly to keyboards of the general type, the above key entries may be made by separate keys exclusively provided therefor or by a smaller number of keys operated in combination with the shift key and/or the like. Here, for purposes of ease of understanding, the following description will be made assuming that there are provided as many keys as described above. As shown in FIG. 3, from the keyboard 3, various commands described above and data are input to the control block 200.

The control block 200 includes a CPU 210, a ROM 220, a character generator ROM (CG-ROM) 230, a RAM 240, a peripheral control circuit (P-CON) 250, all of which are connected to each other by an internal bus 260. The ROM 220 has a control program area 221 for storing control programs executed by the CPU 210 as well as a control data area 222 for storing control data including a color conversion table, a character modification table and the like. The CG-ROM 230 stores font data, i.e. data defining characters, symbols, figures and the like, provided for the tape printing apparatus 1. When code data for identifying a character or the like is input thereto, it outputs the corresponding font data.

The RAM 240 is supplied with power by a backup circuit, not shown, such that stored data can be preserved even when the power is turned off by operating the power key. The RAM 240 includes areas of a register group 241, a text data area 242 for storing text data of letters or the like input by the user via the keyboard 3, a display image data area 243 for storing image data displayed on the display screen 41, a print image data area 244 for storing print image data, a registered image data area 245 for storing registered image data, as well as a print record data area 246 and conversion buffer areas 247 including a color conversion buffer. The RAM 240 is used as a work area for carrying out the control process.

The P-CON 250 incorporates a logic circuit for complementing the functions of the CPU 210 as well as dealing with interface signals for interfacing between the CPU 210 and peripheral circuits. The logic circuit is implemented by gate arrays, a custom LSI and the like. For instance, a timer 251 is incorporated in the P-CON 250 for the function of measuring elapsed time. Accordingly, the P-CON 250 is connected to the sensors of the sensor block 14 and the keyboard 3, for receiving the above-mentioned signals generated by the sensor block 14 as well as commands and data input via the keyboard 3, and inputting these to the internal bus 260 directly or after processing them. Further, the P-CON 250 cooperates with the CPU 210 to output data and control signals input to the internal bus 260 by the CPU 210 or the like, to the driving block 270 directly or after processing them.

The CPU 210 of the control block 200 receives the signals from the sensor block 14, and the commands and data input via the keyboard 3 via the P-CON 250, according to the control program read from the ROM 220, processes font data from the CG-ROM 230 and various data stored in the RAM 240, and delivers control signals to the driving block 270 via the P-CON 250 to thereby carry out position control during printing operations, display control of the display screen 41, and printing control of the print head 7 to carry out printing on the tape T under predetermined printing conditions. In short, the CPU 210 controls the overall operation of the tape printing apparatus 1.

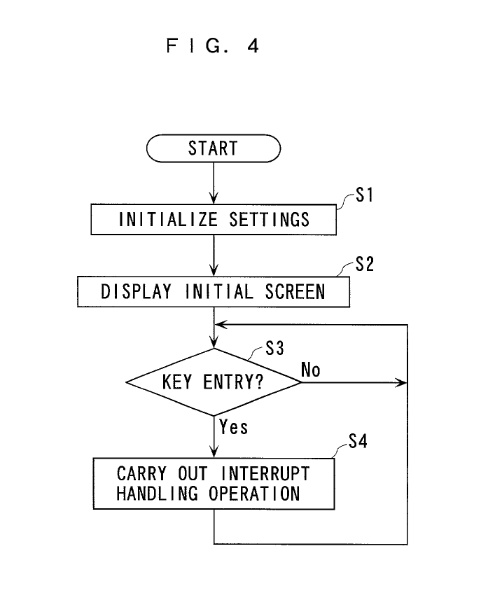

Next, the overall control process carried out by the tape printing apparatus 1 will be described with reference to FIG. 4. As shown in the figure, when the program for carrying out the control process is started e.g. when the power of the tape printing apparatus 1 is turned on, first, at a step S1, initialization of the system including restoration of saved control flags is carried out to restore the tape printing apparatus 1 to the state it was in before the power was turned off the last time. Then, the image that was displayed on the display screen 41 before the power was turned off the last time is shown as an initial screen at a step S2.

The following steps in FIG. 4, that is, a step S3 for determining whether or not a key entry has been made and a step S4 for carrying out an interrupt handling operation are conceptual representations of actual operations. Actually, when the initial screen has been displayed at the step S2, the tape printing apparatus 1 enables an interrupt by key entry (keyboard interrupt), and maintains the key entry wait state (No to S3) until a keyboard interrupt is generated. When the keyboard interrupt is generated (Yes to S3), a corresponding interrupt handling routine is executed at the step S4, and after the interrupt handling routine is terminated, the key entry wait state is again enabled and maintained (No to S3).

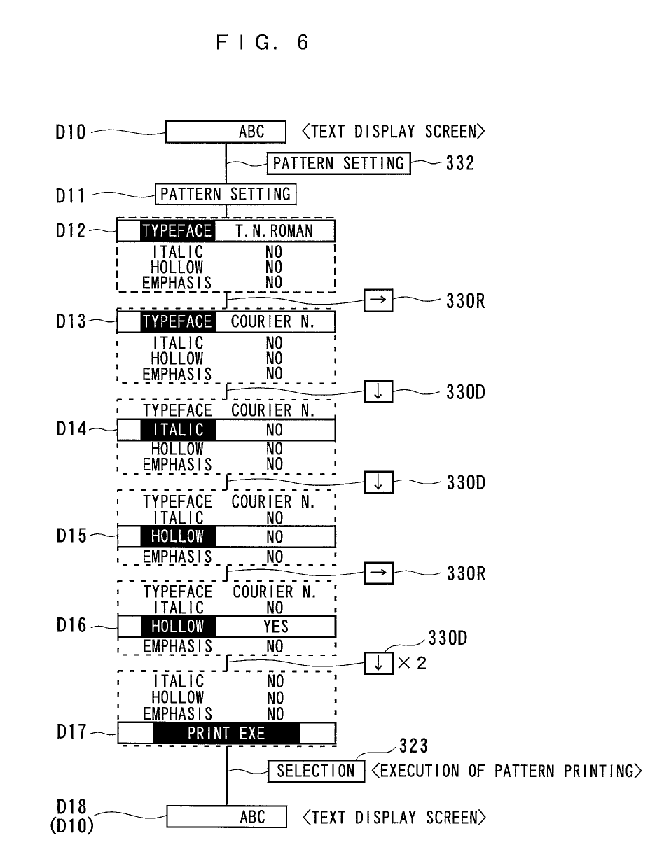

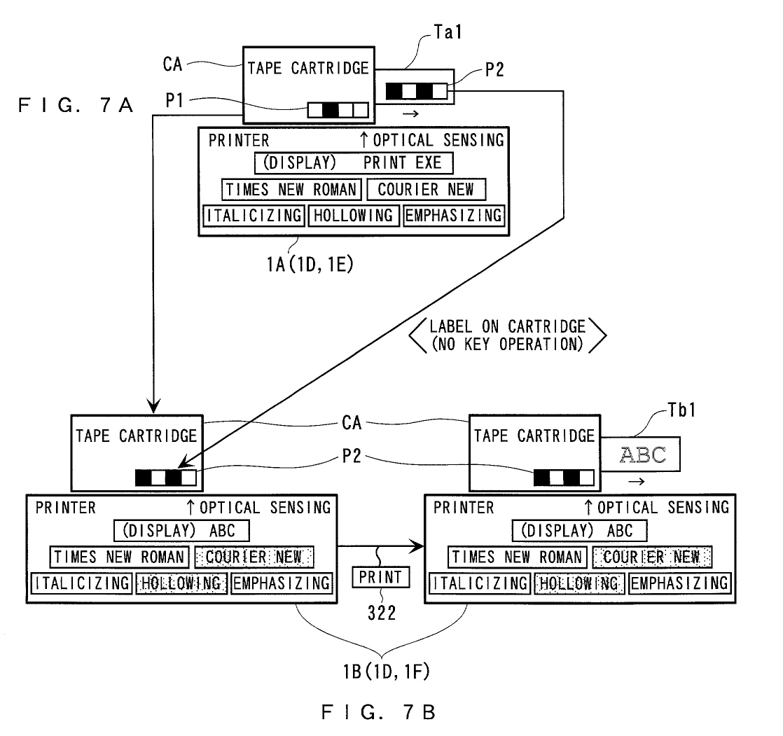

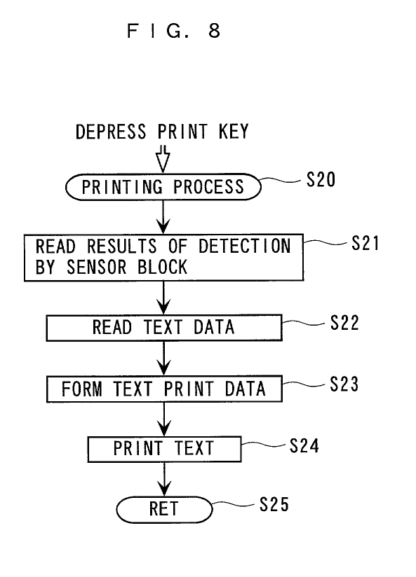

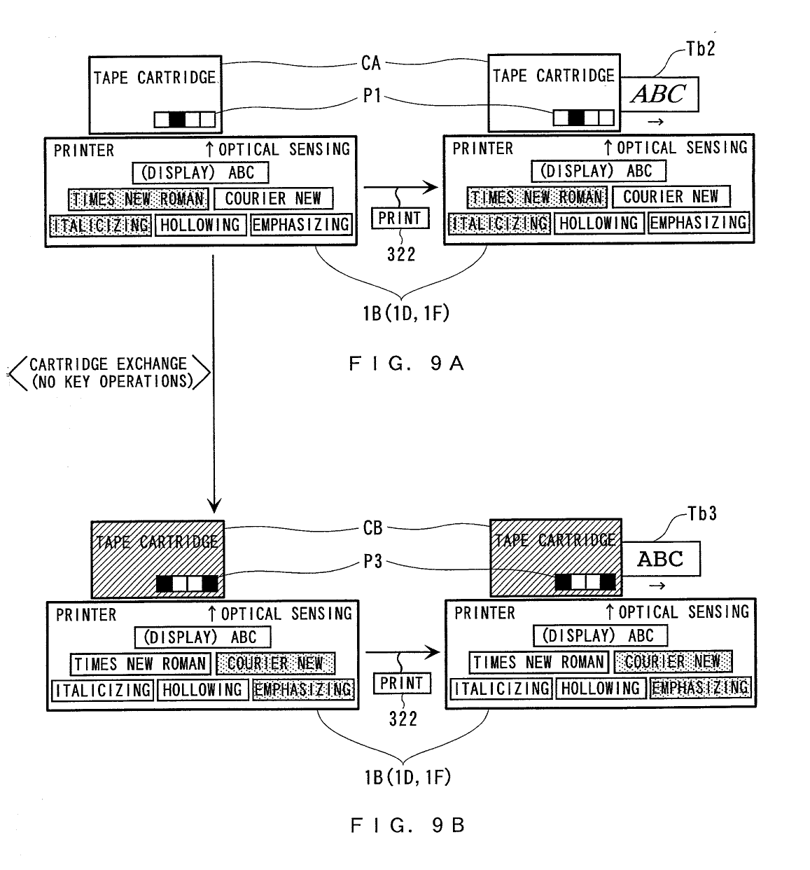

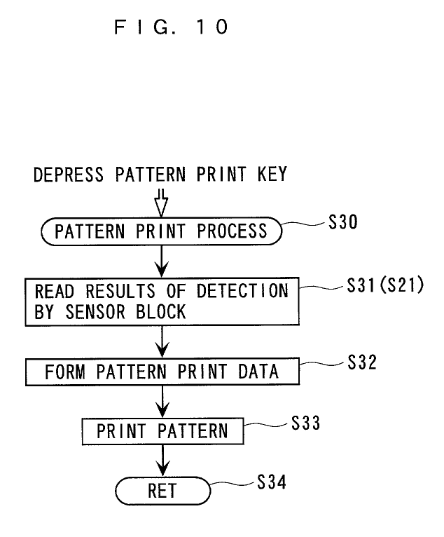

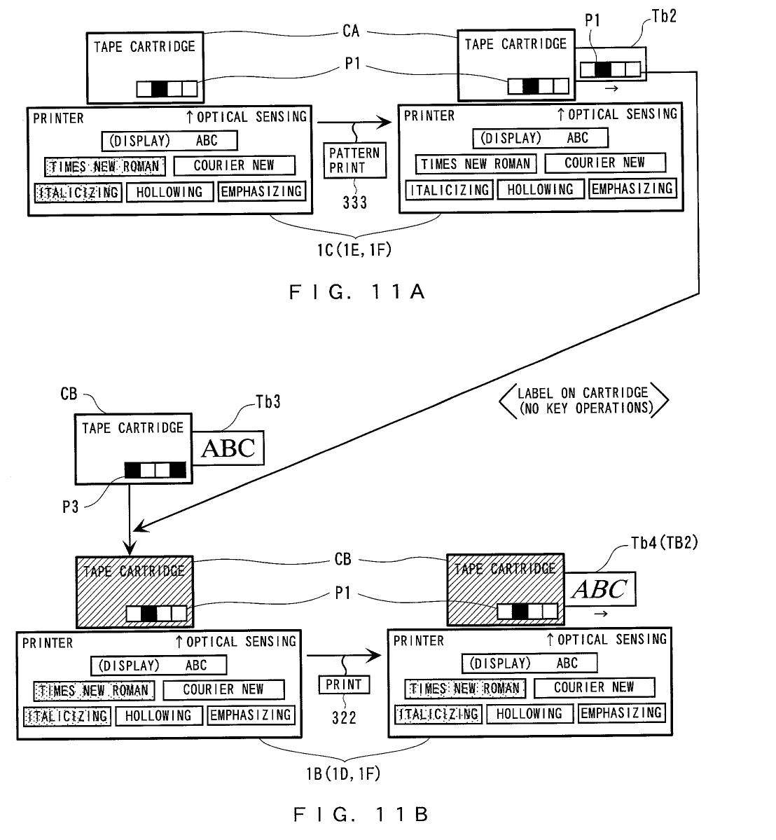

As described above, in the tape printing apparatus 1, main processing operations by the apparatus are carried out by interrupt handling routines, and hence, by depressing any of various printing-related keys [the selection key 323 (see FIGS. 6 to 7), during setting of a pattern, the print key 322 (see FIGS. 8, 9A and 9B) for text printing, and the pattern print key 333 (see FIGS. 10, 11A and 11B) for pattern printing] at a desired time, a print interrupt is generated to start a printing process, whereby the user can print a print image (a character string image, a pattern print image, or the like) based on print image data (text print data, pattern print data, or the like) at the desired time point. In short, operating procedures up to the printing operation can be selectively carried out by the user as he desires.

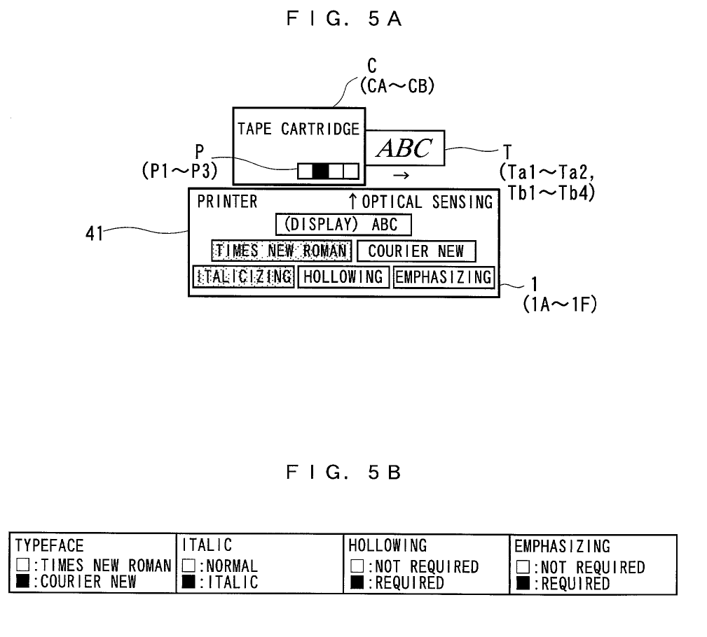

In the following, for purposes of ease of understanding, and for brevity of description, the tape printing apparatus 1 and the tape cartridge C according to the invention are illustrated in a simplified (modeled, imaged) manner as shown in FIG. 5A. More specifically, in the following, as shown in the figure, mages of the tape cartridge C and the tape printing apparatus 1 as well as a tape T represent the tape cartridge C which has a label (detection label) printed with (a pattern image of) a detection pattern P affixed thereto, the tape printing apparatus 1 having the above tape cartridge C mounted therein, and the tape T which is contained in the tape cartridge C to be printed with a print image (a character string image formed based on text print data, a pattern image formed based on pattern print data, or the like), respectively. It should be noted that although the display area shown in the figure corresponds to the above-mentioned display screen 41 of the display 4, for simplicity, it is illustrated as a display area for displaying a line of a character string.

Further, as described hereinabove, although in the tape printing apparatus 1, formats and decorations can be set arbitrarily, in the following, as shown in FIG. 5B, typefaces are employed by way of a typical example of formats, and by way of examples of decorations, italicizing, hollowing, and emphasizing are used. Further, Times New Roman and Courier New are employed as representative typefaces, and it is assumed that they can be represented by a 1-bit binary code. Additionally, it is assumed that as to each of italicizing, hollowing, and emphasizing, whether or not it is applied to printing can be represented by a binary code. This enables the whole desired configuration information to be represented by a 4-bit binary code. Further, although various kinds of colors can be selected, the following description is made assuming that single color (monochrome: e.g. black-and-white) printing is basically carried out. Further, although it is possible, even when a unicolor or monochromatic pattern is used, to employ a multiple-valued pattern, such as a bar code, which expresses information by lengths and widths of bars, in the following, a simple binary code is used which permits values employed to be easily understood simply by viewing the reference figures.

More specifically, as shown in FIG. 5B, if Courier New is set to the typeface, the typeface is represented by “1” of the binary code and printed in black (in a pattern of “▪” in the illustrated example), whereas if Times New Roman is set, the typeface is represented by “0” of the binary code and printed in white (in a pattern of “□” in the illustrated example). When each of the settings of italicizing, hollowing, and emphasizing other than the above setting of typeface is applied, “1” is set to a corresponding bit of the binary code (printed in black: “▪”), whereas when they are not applied, “0” is set (printed in white: “□”). For instance, the detection pattern P affixed to the FIG. 5A tape cartridge C is “□▪□□” (“0100” in the binary code), so that as shown in the figure, an image of a character string “ABC” is printed based on text data in Times New Roman and italic (at the same time without being hollowed or emphasized).

In the following reference figures, to facilitate viewing of the figures and omission of description thereof, a tape Ton which a pattern image (image formed based pattern print data) of a detection pattern is printed as a print image is referred to as a tape Ta (Ta1 and Ta2), and a tape T printed with a character string image (image formed based text print data) as a print image is referred to as a tape Tb (Tb1 to Tb4). Further, information of “Times New Roman”, “italicizing” and the like set or determined is displayed with background thereof being slightly grayed (shaded).

Further, to clearly show the function which the tape printing apparatus 1 utilizes for printing the above pattern image and the character string image, (1) the tape printing apparatus 1 which is capable of carrying out pattern printing (printing a detection pattern) based on settings of patterns is defined as a tape printing apparatus 1A, (2) the tape printing apparatus 1 which is capable of carrying out text printing (printing a character string image) based on pattern detection is defined as a tape printing apparatus 1B, (3) the tape printing apparatus 1 which is capable of carrying out pattern printing based on pattern detection is defined as a tape printing apparatus 1C, (4) the tape printing apparatus 1 which is capable of carrying out pattern printing based on settings of patterns and at the same time carrying out text printing based on pattern detection (apparatus having the functions of (1)+(2)) is defined as a tape printing apparatus 1D, (5) the tape printing apparatus 1 which is capable of carrying out pattern printing based on settings of patterns or pattern detection (apparatus having the functions of (1)+(3)) is defined as a tape printing apparatus 1E, and (6) the tape printing apparatus 1 which is capable of carrying out text printing and pattern printing based on pattern detection (apparatus having the functions of (2)+(3)) is defined as a tape printing apparatus 1F.

Of course, it is possible to employ the tape printing apparatus 1 in place of the respective tape printing apparatuses (1A to 1F) referred to in the above definitions (1) to (6) since the tape printing apparatus 1 according to the present embodiment has all the functions of the apparatuses 1A to 1F, but inversely, each of the tape printing apparatuses 1A to 1F can be replaced by a tape printing apparatus exclusively provided (specialized) for a required function, and can be realized by a tape printing apparatus exclusively provided and reduced in the manufacturing costs thereof. For instance, when a parent and a child are to buy tape printing apparatuses individually, if the tape printing apparatus 1 and the tape printing apparatus 1B (described in the above definition (2)) are purchased, the parent can use the tape printing apparatus 1 according to the present embodiment having all the functions of the apparatuses 1A to 1F, while the child can employ the tape printing apparatus 1B utilizing limited settings (which can be changed by the parent).

Now, detailed description will be made with reference to FIGS. 6 et seq. For instance, if a tape cartridge CA (to which is affixed a detection label with a detection pattern P1=“0100” (hereinafter denoted as “□▪□□” as shown in the figure)) similar to the tape cartridge C described above with reference to FIG. 5A is mounted in the tape printing apparatus 1A (or 1D or 1E or 1) shown in FIG. 7A, and pattern printing is carried out after desired configuration information has been set, (a detection label printed with) a detection pattern P2 conforming to the desired configuration information can be obtained irrespective of the detection pattern P1 on the detection label printed on the tape cartridge CA.

In the above example, when the pattern-setting key 332 is depressed by the user, as shown in FIG. 6, in a state of a text display screen [screen D10: hereinafter, contents displayed on the screen (display area) of the display screen 41 are referred to as the “screen D??” (?represents a digit), and indicated only by D?? in FIG. 6 as well as in the following description] being displayed, an interrupt handling routine for setting a pattern is started, and a message “PATTERN SETTING” notifying that a pattern-setting process is started is displayed (D11). When a certain time period (time period long enough for the user to view or confirm the message) has elapsed after the message is displayed, a first item “TYPEFACE” for setting a pattern is highlighted or displayed in reverse video, and a first option or candidate (candidate set last time or a default candidate, for instance) e.g. of “T. N. ROMAN” indicative of Times New Roman is displayed (D12). It should be noted that in the figure, examples of a plurality of lines (four lines in the example) displayed by the display screen 41 of the display 4 described above are additionally shown by dotted lines in combination of respective examples of display of D12 to D17.

When the right arrow key 330R is depressed by the user in the above state (D12), a next option or candidate of “COURIERN.” indicative of “Courier New” is displayed (D13) When the user thinks this is OK (D13), that is, when the user desires to set “Courier New”, next, the down arrow key 330D is depressed in the state of the screen D13, whereby a next item “ITALIC” which is a second item for setting a pattern is highlighted or displayed in reverse video, and a first option or candidate (e.g. a candidate set last time or a default candidate) “NO” is displayed for selecting or setting a “normal” (which means that “italicizing” is not to be applied) (D14). It should be noted that if the user wants to return the screen from the above state of the screen D13 to the original state (D12), it is possible to return the screen by depressing the right arrow key 330R. Further, if the user wants to return the screen to the typeface selection screen, it is possible to return the screen by depressing the up arrow key 330U. The same applies hereinafter.

When the user thinks this is OK (D14), that is, when the user desires to set the no-italicizing or “normal”, next, the down arrow key 330D is depressed in the state of the screen D14, whereby a next item “HOLLOW” which is a third item for setting a pattern is highlighted or displayed in reverse video, and a first option or candidate (e.g. a candidate set last time or a default candidate) “NO” (which means “hollowing” is not to be applied) is displayed (D15). Of course, if the user desires to use “italicizing”, he may display an option “YES” (which means “italicizing” is to be applied) by operating the right arrow key 330R in the above state of the screen D14. Similarly, since “hollowing” is applied in this example, when the right arrow key 330R is depressed by the user in the state of the screen D15, a next option or candidate “YES” (which means “hollowing” is to be applied) is displayed (D16).

If the user thinks this is OK (D16), next, the down arrow key 330D is depressed in the state of the screen D16, whereby a next item “EMPHASIS” which is a fourth item for setting a pattern is highlighted or displayed in reverse video, and a first option or candidate e.g. of “NO” is displayed. In this example, “emphasizing” is not applied similarly to “italicizing”, and hence the down arrow key 330D is further depressed in the state of the fourth item “EMPHASIS” being displayed, whereby a message “PRNT EXE” (printing execution) for prompting the user to issue a print instruction is highlighted or displayed in reverse video (D17).

When the selection key 323 is depressed by the user in the above state (D17), “Courier New”, “normal” (“italicizing” is not applied), “hollowing (required)”, and “emphasizing (not required)”, which are the items of information (desired configuration information) set in the pattern-setting process, are finally determined for carrying out pattern printing. In the pattern printing, as shown in FIG. 7A, the pattern image of the detection pattern P2 (▪□▪□) is printed on the tape T (Ta1) unwound from the tape cartridge CA, followed by returning to a text display screen (D18: the same as the screen D10 in the figure).

Next, for instance, as shown in FIG. 7B, the portion of the detection pattern P2 (▪□▪□) printed on the tape Ta1 is cut off to form a detection label, and the detection label is labeled to the same tape cartridge CA as the above-mentioned tape cartridge. Then, the tape cartridge CA is mounted in the tape printing apparatus 1B (or 1D or 1F or 1), and text printing is carried out by depressing the print key 322. This makes it possible to print a character string image e.g. of the illustrated character string “ABC” based on the text data according to the desired configuration information of “Courier New” and “hollowing” (without applying “italicizing” or “emphasizing”) read from the detection pattern P2 (▪□▪□) on the detection label affixed to the tape cartridge CA.

In the above process, e.g. as shown in FIG. 8, if the print key 322 is depressed by the user in the state of the text display screen being displayed, an interrupt handling routine for carrying out a normal printing process (S20: text printing process) is started and first, results of detection by the sensor block are read at a step S21. More specifically, as shown in FIG. 7B, in the tape printing apparatus 1B (1D, 1F or 1), the detection pattern P2 (▪□▪□) on the detection label is detected through optical sensing carried out by light detection means of the tape-discriminating sensor 142 (see FIG. 3), so that results of the detection are read out at the step S21.

It should be noted that in the above case, as detection means optical sensor means (light detection means), for instance, which is capable of optically reading (detecting) images to be detected can be employed. Further, if a tape T (Ta1 shown in FIG. 7A: first tape) for forming a detection label (or printing a detection pattern) is formed of a thermoplastic material, and an embossed image can be formed through thermal printing in the tape printing apparatus 1A, detection means for detecting the embossed pattern of the image may be used. The former may include a photocoupler which is capable of optical sensing if an image formed e.g. by a bar code pattern is to be detected, and other light detection means which can detect an image itself similarly to a scanner or the like. Further, the latter includes mechanical detection means which can detect an embossed pattern of an image by using detection switches of a push type which are turned on and off according to the embossed pattern. In the present embodiment, an image to be detected is formed by a pattern image of a detection pattern, and the former light detection means detects the pattern image.

After reading of results of detection by the sensor block is completed at the step S21, as shown in FIG. 8, next, at a step S22, text data (e.g. of “ABC”) is read from the text data area 242 (see FIG. 3) of the RAM 240 for storing the same, and then image data thereof is formed in the print image data area 244, based on corresponding font data from the CG-ROM 230 [and at the same time according to the desired configuration information represented by the detection pattern P2 (▪□▪□) i.e. “Courier New” and “hollowing” (without applying “italicizing” or “emphasizing”)]. More specifically, at a step S23, text print data is generated as print image data representative of a character string image (“ABC”).

Next, at a step S24, the character string image (“ABC”) is printed on the tape T in the tape cartridge CA based on the text print data (Tb1 in FIG. 7B), that is, text printing is carried out, and the printing process (S20) is terminated at a step S25, followed by the screen returning to the original text display screen. Although in the above-mentioned example, the detection label with the detection pattern P2 was affixed to the same tape cartridge CA as produced the detection label, any tape cartridge may be employed as desired so long as it can be mounted in the tape printing apparatus 1B (1D, 1F or 1).

As described hereinabove, in the tape printing apparatus 1A (1D, 1E or 1), the tape cartridge CA (first tape cartridge) containing the tapeT (first tape) is mounted, and desired configuration information is input (see FIGS. 5B and 6). Then, in order to produce a detection label which is printed with a pattern image (to-be-detected image) of a detection pattern (detection pattern P2 in FIG. 7A, for instance) detectable by light detection means (predetermined detection means), and labeled on an arbitrary tape cartridge C, the pattern image (to-be-detected image) of the detection pattern which is to be printed on the detection label for indicating the desired configuration information is printed on the tape T (first tape) such that the pattern image can be detected by the light detection means. This makes it possible to produce a detection label by cutting off a portion (e.g. the portion of the detection pattern P2 shown in FIG. 7A) of the printed tape T (first tape), which includes a pattern image (to-be-detected image) of a detection pattern, and affix the detection label to a tape cartridge CA (desired tape cartridge), thereby causing the tape cartridge CA to detectably hold the desired configuration information.

Further, as described hereinbefore, in the tape printing apparatus 1, various kinds of formats and decorations can be set as desired. For instance, it is possible to set decorations, such as a so-called character decoration e.g. hatching, underlining, boxing, etc. or a background decoration (including a background pattern, an illustration and the like) by using the decoration-setting key, and set colors (including gray levels, color saturation, luster, transparency, and so forth) of characters, a background, and a decoration by operating the color-setting key. Further, it is possible to set formats other than typefaces, such as formats for use with labels designed specifically for videos, floppy discs (FDs), compact discs (CDs), mini discs (MDs). All the above formats and decorations are included in information which can be set by the user as he desires, that is, desired configuration information, and if a detection label printed with a to-be-detected image indicative of a format and a decoration is provided (produced), and labeled on an arbitrary tape cartridge C, it is possible to cause the tape cartridge C to hold various kinds of desired configuration information. It should be noted that in a type of the apparatus which is capable of inputting the Japanese language, various variants of typefaces, such as Mincho typeface and Gothic typeface, can be set, and it is also possible to set typefaces other than Mincho typeface and Gothic, such as Kaisyo typeface, Gyousyo typeface, and the like.

In the above case, i.e. when the tape cartridge C is caused to hold various kinds of desired configuration information as described above, similarly to the present embodiment, it is preferred that the desired configuration information includes information of designation of at least one of the typeface, a decoration, and a color for use in printing. This makes it possible to print a pattern image (to-be-detected image) of a detection pattern indicating the information (desired configuration information) on the tape T (first tape) such that the pattern image can be detected. Therefore, a portion including the to-be-detected image is cut off from the tape T for producing a detection label, and the detection label is labeled on an arbitrary tape cartridge, whereby it is possible to cause the tape cartridge to detectably hold the desired configuration information.

Further, in the present embodiment, a to-be-detected image is a pattern image formed by patterning desired configuration information in a predetermined format, and the pattern image is printed on the tape T (first tape) in a manner such that it can be detected. Hence, if a portion including the pattern image is cut off from the tape T to make a detection label, and the detection label is labeled on an arbitrary tape cartridge, it is possible to hold the pattern image as detectable desired configuration information.

Further, the pattern of a pattern image indicates a code formed by encoding desired configuration information (for instance, the FIG. 7A detection pattern P2 is a pattern (▪□▪□) indicative of a 4-bit binary code “1010”), and the pattern image is printed on the tape T (first tape) such that it can be detected, so that if a portion including the pattern image is cut off from the tape T to make a detection label, and the detection label is labeled on an arbitrary tape cartridge, it is possible to cause the tape cartridge to hold the pattern image as desired configuration information which can be detected as a code (binary code) indicated by the pattern of the pattern image. Further, in the present embodiment, the pattern image is set as a unicolor pattern image representing the code in a single color, so that it is possible to carry out unicolor or monochromatic printing. This makes it possible to reduce costs for causing the tape cartridge C to hold desired configuration information. Further, in this case, the unicolor pattern may be not only a binary code represented by the presence or absence of a single color but also a multiple-valued pattern, such as a bar code represented by the lengths and widths of bars.

Further, the tape cartridge CA mounted in the tape printing apparatus 1B (1D, 1F or 1) in FIG. 7B contains the tape T (tape which is used as the Tb1 after printing: second tape) for use in printing a character string image, and at the same time to the tape cartridge CA is affixed the detection label which is produced by cutting off the portion including the pattern image (to-be-detected image) of the detection pattern P2 from the tape Ta1 (first tape). The pattern image is printed by the tape printing apparatus 1A (1D, 1E or 1) Consequently, the tape cartridge CA is not only a tape cartridge C containing a tape T (second tape) but also a tape cartridge C holding desired configuration information by a detection label.

Also, the above tape cartridge CA is capable of containing the same tape T (first tape) as employed in providing the detection label printed with the detection pattern P2, as a tape (second tape) to be used as the tape Tb1 after printing. Further, the tape cartridge CA can be mounted in the tape printing apparatus 1A (1D, 1E or 1: first tape printing apparatus) as the tape cartridge C (first tape cartridge) for use in producing the detection label. Hence, the tape cartridge CA can function as a tape cartridge C for holding desired configuration information by a detection label labeled thereon, and at the same time it is capable of functioning as a tape cartridge c which can be mounted in the tape printing apparatus 1A (1D, 1E or 1: first tape printing apparatus) for printing a new pattern image (to-be-detected image) of a detection pattern on a second tape (first tape), and hence permits a new detection label to be produced for causing another desired tape cartridge C to hold the desired configuration information.

Next, in the tape printing apparatus 1B (1D, 1F or 1) described hereinbefore with reference to FIGS. 7A to 8, the same tape cartridge C (second tape cartridge) as the above tape cartridge CA is mounted, and a pattern image (to-be-detected image) of a detection pattern which is printed on a detection label affixed to the tape cartridge C is detected. Then, based on results of the detection, a character string image (object image) is printed on a tape T (second tape) unwound from the tape cartridge C (second tape cartridge).

Therefore, for instance, as shown in FIGS. 9A and 9B, when the tape cartridge CA having the detection label with the detection pattern P1 (□▪□□) affixed thereto is mounted, the character string image “ABC” can be printed by text printing in “Times New Roman” and “italic” (without applying “hollowing” or “emphasizing”) (Tb2), whereas when a tape cartridge CB having a detection label with a detection pattern P3 (▪□□▪) affixed thereto is mounted, the character string image “ABC” can be printed by text printing in “Courier New” and in “an emphasized manner” (without applying “italicizing” or “hollowing”) (Tb3). In the meanwhile, the user is only required to replace the tape cartridge with a tape cartridge C to be mounted, without carrying out any key operations for configuration of printing.

More specifically, in the tape printing apparatus 1B (1D, 1F or 1), if only a tape cartridge C (second tape cartridge) is mounted, a character string image (object image) can be printed on a tape T (second tape) based on a pattern image (to-be-detected image) of a detection image which is printed on a detection label affixed to the tape cartridge C (second tape cartridge), without newly setting desired configuration information. As a result, this tape printing apparatus may dispense with the function of setting desired configuration information, that is, it may be the tape printing apparatus 1B (or 1F).

Of course, in the above case, data of the character string can be input, the desired configuration information represented by the to-be-detected image includes information concerning printing of the character string image, and the print image is a character image that is printed according to the desired configuration information and based on the data of the character string. Therefore, simply by inputting the data of the character string, it is possible to print the character string image according to the desired configuration information represented by the to-be-detected image, without newly setting information concerning printing of the character string image.

In the tape printing apparatus 1B (1D, 1F or 1), the pattern image (to-be-detected image) of the detection pattern is detected and then, based on the detected pattern image, the character string image (object image) is printed. In other words, text printing is carried out based on results of pattern detection, but as described hereinbefore, according to the printing apparatus 1 of the present embodiment, it is possible to carry out pattern printing based on pattern detection.

For instance, as shown in FIG. 11A, in the tape printing apparatus 1C (1E, 1F or 1), the tape cartridge CA (to which is affixed the detection label with the detection pattern P1 (□▪□□) described above with reference to FIGS. 5A, 7A and 9A is mounted, and pattern printing is carried out by depressing the pattern print key 333. This makes it possible to detect the pattern image of the detection pattern P1 (□▪□□) on the detection label affixed to the tape cartridge CA, and print the same pattern image of the detection pattern P1 (□▪□□) on the tape T (Ta2).

In this case, referring to FIG. 10, when the pattern print key 333 is depressed by the user in the state of the text display screen being displayed, for instance, an interrupt handling routine for carrying out a pattern printing process (S30) is started, and first, the pattern image of the detection pattern P1 (□▪□□) on the detection label is detected through optical sensing carried out by the light detection means of the tape-discriminating sensor 142 (see FIG. 3), so that results of the detection are read out at a step S31 (the same as the step S21 in FIG. 8). Next, the pattern image is formed in the print image data area 244 of the RAM 240. In short, patternprint data is generated as print image data representative of the pattern image (□▪□□) at a step S32. Then, the pattern image (□▪□□) is printed on the tape T unwound from the tape cartridge CA based on the pattern print data (Ta2), that is, pattern printing is executed at a step S33, and the pattern printing process (S30) is terminated at a step S34, followed by the screen returning to the original text display screen.

As described above, in the tape printing apparatus 1C (1E, 1F or 1), the same tape cartridge C (second tape cartridge) as the above tape cartridge CA is mounted, and a pattern image (to-be-detected image) of a detection pattern which has been printed on a detection label affixed to the tape cartridge C is detected. Then, based on results of the detection, the same pattern image (print image, second to-be-detected image) as the detected pattern image is printed on the tape T (second tape) unwound from the tape cartridge C (second tape cartridge).

Next, for instance, as shown in FIG. 11B, the portion including the pattern image (□▪□□) of the detection pattern P1 (□▪□□) is cut off from the tape Ta2 to form a detection label, and the detection label is labeled to the tape cartridge CB described above with reference to FIG. 9B. Then, the tape cartridge CB is mounted in the tape printing apparatus 1B (1D, 1F or 1), and text printing is carried out by depressing the print key 322. Thus, according to the desired configuration information represented by the detection pattern P1 (□▪□□) on the detection label affixed to the tape cartridge CB, i.e. “Times New Roman” and “italicizing” (without applying “hollowing” or “emphasizing”), a character string image e.g. of the character string “ABC” can be printed based on the text data, as shown in the figure (Tb4 according to the same configuration as used in Tb2 in FIG. 9A).

More specifically, as described hereinbefore with reference to FIG. 9B, in the tape printing apparatus 1B (1D or 1F or 1), when the detection label having the detection pattern P3 (▪□□▪) has been affixed to the mounted tape cartridge CB, according to the detection pattern P3 (▪□□▪) and by text printing, the character string image “ABC” can be printed in “Courier New” and in “an emphasized manner” (without applying “italicizing” or “hollowing”) (Tb3), whereas as shown in FIG. 11B, when the detection label having the detection pattern P1 (□▪□□) is labeled to the tape cartridge CB and the tape cartridge CB is mounted in the tape printing apparatus 1B (1D or 1F or 1), the character string image “ABC” can be printed by text printing in “Times New Roman” and “italic” (without applying “hollowing” or “emphasizing”) (Tb4). In the meanwhile, the user is only required to affix a new detection label to the tape cartridge CB without carrying out any key operations for configuration of printing.

As described above, in the tape printing apparatus 1C (1E, 1F or 1), a pattern image (to-be-detected image) of a detection pattern which has been printed on a detection label affixed to the mounted tape cartridge C is detected. Then, based on results of the detection, the same pattern image (object image, second to-be-detected image) as the detected pattern image is printed on the tape T (second tape) unwound from the tape cartridge C (second tape cartridge) In this case, the print image is identical to the to-be-detected image, and hence based on the to-be-detected image, the same to-be-detected image as the above to-be-detected image can be printed on the tape T (second tape) simply by mounting the tape cartridge C, even if the desired configuration information is not newly set or even if the information cannot be newly set. Then, by cutting off a printed portion of the tape T, it is possible to produce a new detection label for causing an arbitrary tape cartridge C other than the mounted tape cartridge C to hold the desired configuration information.

As a result, if the tape printing apparatus 1C (1E, 1F or 1) is employed, it is possible to produce one detection label after another, which is printed with a to-be-detected image representative of the same desired configuration information, and if the detection labels are affixed to one desired tape cartridge C after another, it is possible to cause the tape cartridges C to hold the same desired configuration information, one after another. It should be noted that in this case, the tape printing apparatus may be an apparatus of a type which detects a to-be-detected image for printing the same without further processing, or may be an apparatus of a type which decodes desired configuration information once, and then generates a new to-be-detected image according to the desired configuration information for printing the image.

Next, the label-producing method according to the present embodiment will be summarized hereinafter. In the above-mentioned label-producing method, first, as described above with reference to FIG. 7A, the tape cartridge CA (first tape cartridge) accommodating the tape T (first tape) is mounted in the tape printing apparatus 1A (1D, 1E or 1: first tape printing apparatus), and the desired configuration information is input as described above with reference to FIG. 6. Then, the pattern image (“▪□▪□”: to-be-detected image) of a detection pattern (P2 (▪□▪□), for instance) representative of the desired configuration information is printed on the tape T such that the pattern image can be detected by the light detection means (Ta1 in FIG. 7), and a portion including the pattern image is cut off from the tape T for producing a detection label. Thus, simply by labeling the detection label to an arbitrary tape cartridge C, it is possible to cause the tape cartridge C to detectably hold the desired configuration information.

Therefore, next, the detection label is labeled to a tape cartridge C (second tape cartridge) containing the tape T (second tape). In this case, the tape cartridge C may be an arbitrary one so long as the tape cartridge can be mounted in the tape printing apparatus 1. This makes it possible to cause the arbitrary tape cartridge C (second tape cartridge) to detectably hold desired configuration information. Further, a first tape cartridge and a second tape cartridge may be the same tape cartridge C, in the case of the tape cartridge CA described above with reference to FIGS. 7A and 7B. In this case, if the detection label printed with the to-be-detected image is labeled to the tape cartridge CA which was used as the first tape cartridge in printing the to-be-detected image, the tape cartridge CA can be further employed in printing a print image.

Next, the arbitrary tape cartridge C (second tape cartridge) is mounted in the tape printing apparatus 1 (second tape printing apparatus) having the light detection means (detection means), and the pattern image (to-be-detected image) of the detection pattern which was printed on the detection label affixed to the second tape cartridge is detected. Then, based on the detected image, the print image is printed on the tape T (second tape) unwound from the second tape cartridge, and a portion including the print image of the second tape is cut off, whereby a print image label is produced. In other words, in the second tape printing apparatus, simply by mounting the second tape cartridge, the print image can be printed on the second tape based on the to-be-detected image printed on the detection label without setting desired configuration information, and by cutting off a portion including the print image from the second tape, it is possible to produce a print image label.

It should be noted that in the above case, optical sensor means (light detection means) may be used as detection means as in the present embodiment, and if the first tape printing apparatus has the function of forming an embossed image as a to-be-detected image, the detection means may be formed by sensor means which is capable of detecting an embossed pattern of the embossed image. Further, in the above case, the tape printing apparatus 1A (1D, 1E or 1: first tape printing apparatus) is only required to have the minimum function of setting desired configuration information, and printing a to-be-detected image representative of the desired configuration information. In this sense, it is possible to employ the tape printing apparatus 1A. Further, the second tape printing apparatus is only required to have the minimum function of detecting a to-be-detected image, and printing a print image, and accordingly the second tape printing apparatus may be a type which does not have the function of setting desired configuration information. Therefore, the first tape printing apparatus and the second tape printing apparatus can be configured as different apparatuses from each other such that they are usable for different purposes.

In the present embodiment, the tape printing apparatus 1A (1D, 1E or 1) is employed as the tape printing apparatus 1 corresponding to the above first tape printing apparatus, and the tape printing apparatus 1B (1D, 1F or 1) and the tape printing apparatus 1C (1E, 1F or 1) are described as the tape printing apparatuses 1 corresponding to the second tape printing apparatus. Therefore, in the case of the former, the tape printing apparatus 1B (or 1F: second tape printing apparatus), and in the case of the latter, the tape printing apparatus 1C (or 1F: second tape printing apparatus) can be configured to be of a different type from the tape printing apparatus 1A (or 1E: first tape printing apparatus ), each serving a different purpose from the first tape printing apparatus.

On the other hand, it is also possible to configure the first tape printing apparatus and the second tape printing apparatus as one identical tape printing apparatus such that one tape printing apparatus has the functions of setting desired configuration information, printing to-be-detected images, detecting to-be-detected images, and printing print images. In the case of the former, the tape printing apparatus 1D (or 1) which is common to the tape printing apparatus 1A (1D, 1E or 1: first tape printing apparatus) and the tape printing apparatus 1B (1D, 1F or 1: second tape printing apparatus) can be employed. Further, in the case of the latter, the tape printing apparatus 1E (or 1) which is common to the tape printing apparatus 1A (1D, 1E or 1: first tape printing apparatus) and the tape printing apparatus 1C (1E, 1F or 1: second tape printing apparatus) can be employed.

In the case of the former, i.e. when the tape printing apparatus 1B (1D, 1F or 1) is used as the second tape printing apparatus, according to the label-producing method of the present embodiment, data of a character string (“ABC”, for instance) is input to the tape printing apparatus 1B (1D, 1F or 1: second tape printing apparatus), and information concerning printing of a character string image is included in desired configuration information which is indicated by a pattern image (to-be-detected image) of a detection pattern (e.g. detection pattern P2 (▪□▪□) shown in FIG. 7B) Further, a print image is a character image (“ABC”) which is printed based on the data of the character string (“ABC”) and according to the desired configuration information (e.g. “Courier New”, “normal” (which means “italicizing” is not applied), “hollowing (required)”, and “emphasizing (not required)”) (e.g. Tb1 in FIG. 7B).

Therefore, in the tape printing apparatus 1A (1D, 1E or 1: first tape printing apparatus), information concerning printing of a character string image is set as desired configuration information, a pattern image (to-be-detected image) of a detection pattern (e.g. pattern P2 (▪□▪□) representative of the desired configuration information is printed on a tape T (first tape) (Ta1), and a detection label produced by cutting off the printed portion of the tape T is labeled to a tape cartridge C (second tape cartridge), whereby it is possible to cause the tape cartridge C (second tape cartridge) to hold the printing information of the character string image as the desired configuration information.

Further, in the tape printing apparatus 1B (1D, 1F or 1: second tape printing apparatus), simply by detecting the pattern image (to-be-detected image) of the detection pattern (e.g. pattern P2 (▪□▪□), and inputting the data of the character string (e.g. “ABC”), it is possible to print the character string image (“ABC”) (Tb1) according to the desired configuration information represented by the to-be-detected image, without setting the information concerning printing of the character string image again, and produce a character string image label by cutting off the printed portion of the tape T.

On the other hand, in the case of the latter, i.e. when the tape printing apparatus 1C (1E, 1F or 1) is employed as the second tape printing apparatus, according to the label-producing method of the present embodiment, as described hereinbefore with reference to FIG. 11A, the tape printing apparatus 1C (1E, 1F or 1: second tape printing apparatus) detects a pattern image (to-be-detected image) of a detection pattern (e.g. pattern P1 (□▪□□)) affixed to a mounted tape cartridge C. In this case, a print image is the same image as the to-be-detected image, that is, the pattern image (print image, second to-be-detected image) of the detection pattern (e.g. pattern P1 (□▪□□)).

Therefore, if only a tape cartridge C (second tape cartridge) is mounted in the tape printing apparatus 1C (1E, 1F or 1: second tape printing apparatus), the same print image (second to-be-detected image) as the to-be-detected image can be printed on the tape T (second tape) (Ta2) based on the to-be-detected image even if the desired configuration information is not newly set or even if the information cannot be newly set. Then, by cutting off a printed portion of the tape T, it is possible to produce a new detection label for causing an arbitrary tape cartridge C other than the tape cartridge C mounted as the second tape cartridge to hold the desired configuration information.

That is, if the tape printing apparatus 1C (1E, 1F or 1: second tape printing apparatus) is employed, it is possible to produce one detection label after another, which is printed with the pattern image (to-be-detected image) of a detection pattern (e.g. pattern P1 (□▪□□)) representative of the same desired configuration information, and if the detection labels are affixed to desired tape cartridges C, one after another, it is possible to cause the tape cartridges C to hold the same desired configuration information, one after another. It should be noted that in this case, the tape printing apparatus 1C (1E, 1F or 1: second tape printing apparatus) may be of a type which detects the to-be-detected image for printing the same without further processing, or may be an apparatus of a type which decodes desired configuration information once, and then newly generates a to-be-detected image according to the desired configuration information for printing the image.

In the present embodiment, in the above latter case i.e. when the tape printing apparatus 1C (1E, 1F or 1) is employed as the second tape printing apparatus, the tape printing apparatus 1B (1D, 1F or 1) is further used as a third tape printing apparatus. Although the tape printing apparatus 1C (1E, 1F or 1) can be further employed as the third tape printing apparatus, in this case, the description thereof would be a repetition of the above description made in the above case in which the tape printing apparatus 1C (1E, 1F or 1) is employed as the second tape printing apparatus, and hence it is omitted.

Therefore, in the label-producing method described hereinabove, as shown in FIGS. 11A and 11B, a pattern image (second to-be-detected image) of a detection pattern (e.g. pattern P1 (□▪□□)) is printed on a tape T (Ta2: second tape) by the tape printing apparatus 1C (1E, 1F or 1: second tape printing apparatus), and a portion including the pattern image (P1 (□▪□□)) is cut off from the tape to form a print image label. Then, the print image label is labeled to a tape cartridge CB (third tape cartridge) containing a tape T (third tape) as a second detection label, and the tape cartridge CB is mounted in the tape printing apparatus 1B (1D, 1F or 1: third tape printing apparatus).

The tape printing apparatus 1B (1D, 1F or 1: third tape printing apparatus) detects the pattern image (second to-be-detected image) of the detection pattern (e.g. pattern P1 (□▪□□)) which is printed on the second detection label affixed to the tape cartridge CB. Then, based on the second to-be-detected image, the third tape printing apparatus prints a second print image which is an image different from the second to-be-detected image, on the tape T (third tape) unwound from the tape cartridge CB (third tape cartridge), and cuts off a portion including the second print image from the tape T (third tape), thereby producing a second print image label.

In other words, similarly to the tape printing apparatus 1C (1E, 1F or 1: second tape printing apparatus), the tape printing apparatus 1B (1D, 1F or 1: third tape printing apparatus) in this case detects a to-be-detected image (second to-be-detected image) printed on a detection label (second detection label). However, differently from the tape printing apparatus 1C (1E, 1F or 1: second tape printing apparatus), the tape printing apparatus 1B (1D, 1F or 1: third tape printing apparatus) prints a print image (second print image) different from the detected image. Thus, if only a tape cartridge CB (third tape cartridge) is mounted therein, the tape printing apparatus 1B (1D, 1F or 1: third tape printing apparatus) can print a second print image on a third tape based on a pattern image (second to-be-detected image) of a detection pattern (e.g. P1 (□▪□□)) without newly setting the desired configuration information. After the second print image has been printed, the printed portion of the third tape is cut off to produce a second print image label.

Of course, in the present embodiment, data of a character string (“ABC”, for instance) is input to the tape printing apparatus 1B (1D, 1F or 1: third tape printing apparatus), and information concerning printing of a character string image is included in desired configuration information which is represented by a pattern image (second to-be-detected image) of a detection pattern (e.g. P1 (□▪□□)). Further, a second print image is a character image (“ABC”) which is printed based on the data of the character string (“ABC”) and according to the desired configuration information (for instance, “Times New Roman” and “italicizing” (without applying “hollowing” or “emphasizing”) (Tb4 appearing in FIG. 11B, for instance).

Therefore, in the tape printing apparatus 1A (1D, 1E or 1: first tape printing apparatus), information concerning printing of a character string image is set as desired configuration information, a pattern image (to-be-detected image) of a detection pattern (e.g. P1 (□▪□□)) representative of the desired configuration information is printed on a tape T (first tape), and a detection label produced by cutting off the printed portion of the tape T is labeled to a tape cartridge CA (second tape cartridge). In the tape printing apparatus 1C (1E, 1F or 1: second tape printing apparatus), a pattern image (second to-be-detected image) of a detection pattern (e.g. P1 (□▪□□)), which image-is the same image as the above to-be-detected image, is printed on a tape T (second tape) (Ta1), and a second detection label produced by cutting off the printed portion of the tape T (second tape) is labeled to a tape cartridge CB (third tape cartridge). Thus, it is possible to cause the tape cartridge CA (second tape cartridge) and the tape cartridge CB (third tape cartridge) to hold the information concerning printing of the character string image as the desired configuration information.

Further, in the tape printing apparatus 1B (1D, 1F or 1: third tape printing apparatus), if only the pattern image (second to-be-detected image) of the detection pattern (e.g. P1 (□▪□□)) is detected, and the data of the character string (e.g. “ABC”) is input, it is possible to print the character string image (“ABC”) (Tb4) according to the desired configuration information (for instance, “Times New Roman” and “italicizing” (without applying “hollowing” or “emphasizing”) represented by the second to-be-detected image, without newly setting the information concerning printing of the character string image, and produce a character string image label by cutting off the printed portion of the tape T.

Further, in the above case, the tape printing apparatus 1C (1E, 1F or 1: second tape printing apparatus) is only required to have the minimum function of detecting a to-be-detected image, and printing a second to-be-detected image which is the same image as the detected image. In this sense, the tape printing apparatus 1C can be employed. Further, the tape printing apparatus 1B (1D, 1F or 1: third tape printing apparatus) is only required to have the minimum function of detecting a to-be-detected image (second to-be-detected image), and printing a character string image. In this sense, the tape printing apparatus 1B can be employed. Therefore, the second tape printing apparatus and the third tape printing apparatus can be configured as apparatuses of different types from each other to be used for respective purposes. More specifically, the tape printing apparatus 1C (or 1E: second tape printing apparatus) and the tape printing apparatus 1B (or 1D: third tape printing apparatus) can be configured as apparatuses of different types from each other to be used for respective purposes.

On the other hand, it is also possible to configure the second tape printing apparatus and the third tape printing apparatus as one identical tape printing apparatus 1 which, based on results of detection of a to-be-detected image, is capable of printing an image (second to-be-detected image) identical to the to-be-detected image, and a second object mage different from the to-be-detected image. In this case, the tape printing apparatus 1F (or 1), which is common to the tape printing apparatus 1C (1E, 1F or 1: second tape printing apparatus) and the tape printing apparatus 1B (1D, 1F or 1: third tape printing apparatus), can be employed.

From the viewpoint of a label-producing method, similarly to the present embodiment, it is preferred that desired configuration information includes information of designation of at least one of a typeface, a decoration and a color for use in printing. This makes it possible to set the information as desired configuration information, print a to-be-detected image representative of the desired configuration information, and produce a detection label printed with the to-be-detected image. And, by labeling the detection label to a tape cartridge, it is possible to cause the tape cartridge to hold the desired configuration information. Further, by detecting the to-be-detected image, a print image can be printed based on the detected image thereby making it possible to produce a print image label printed with the print image.

Further, in the present embodiment, a to-be-detected image is a pattern image formed by patterning desired configuration information in a predetermined format, a pattern of the pattern image indicates a code formed by encoding the desired configuration information (for instance, the FIG. 7A detection pattern P2 is a pattern (▪□▪□) indicative of a 4-bit binary code “1010”), and the pattern image is printed on a tape T in a detectable manner. Hence, if a detection label is produced by cutting off a printed portion of the tape, and labeled on an arbitrary tape cartridge, it is possible to cause the tape cartridge to hold the pattern image as desired configuration information which can be detected as a code (binary code) indicated by the pattern of the pattern image. Further, if the pattern image is detected, and a print image is printed based on the detected image, it is possible to produce a print image label. Further, since the pattern image is a unicolor or monochromatic pattern image representative of a code of the pattern image in a single color, it is possible to carry out unicolor or monochromatic printing. This makes it possible to reduce costs for causing the tape cartridge to hold desired configuration information.

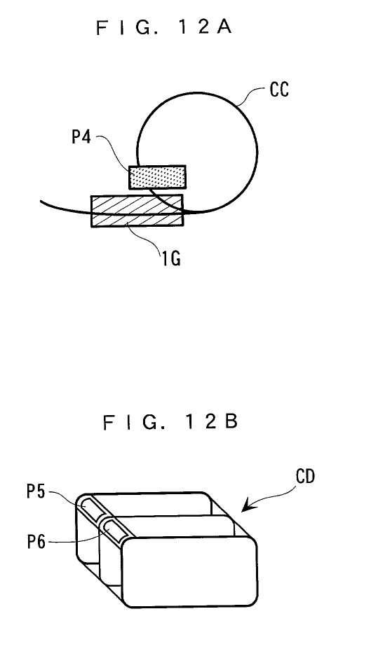

Although in the above-mentioned embodiment, a to-be-detected image is formed by patterning desired configuration information such that the desired configuration information is indicated by a pattern of the pattern image, this is not limitative, but a to-be-detected image, as a print image showing desired configuration information as it is, may be printed and detected for printing the print image without further processing. Further, although in the above embodiment, a tape cartridge C mountable within a tape printing apparatus is employed by way of example, this is not limitative, but it is possible to use a tape cartridge CC, shown in FIG. 12A, holding a large roll of a tape, or a multi deck tape cartridge CD, shown in FIG. 12B, having a plurality of decks for holding a plurality of tapes.

For instance, in the case of FIG. 12A, it can be contemplated that a detection label on which a print image (desired configuration information) is printed as it is as a to-be-detected image P4 is labeled to the tape cartridge CC, and that as the tape printing apparatus, there is employed a tape printing apparatus 1G which has almost no entry block, and simply detects the to-be-detected image P4 for printing without further processing. Further, in the case of FIG. 12B, it can be contemplated that a detection label which is printed with a to-be-detected image P5, P6 or the like each indicating different desired configuration information is labeled to a cartridge on each deck of the multideck (in the example shown in FIG. 12B, two-deck) tape cartridge CD, and that when printing is carried out on a tape contained in the cartridge on each deck, the to-be-detected image P5, P6 or the like printed on each detection label is detected for printing according to results of the detection.

Further, it can be contemplated that although not particularly shown, whenever a cartridge of a refillable type, i.e. a cartridge that can be refilled with a new tape, is refilled, an existing detection label is changed to a new one that indicates desired configuration information corresponding to the new tape, or that tapes and detection labels corresponding to the tapes are combined for sale.

Further, in the above case of object images being printed as they are, for instance, it is possible to print images of fixed-form character strings, e.g. character string images indicating fixed-form messages, such as (1) “Thank you for your constant patronage.”, (2) “CONFIRMED”, (3) “FRAGILE/HANDLE WITH CARE” and the like, as to-be-detected images without further processing, and cut off the printed portions for producing detection labels. Further, it is also possible to register one or more fixed-form character strings (e.g. the above three messages (1) to (3)) in advance, print a designation image for designating one of the registered fixed-form character strings as a to-be-detected image, and cut off the printed portions for producing a detection label. Here, in the former case, since the to-be-detected images are character images, they can be printed by a normal tape printing apparatus, and information thereof can be regarded as a kind of desired configuration information. Further, in the latter case as well, information of character images can be regarded as a kind of desired configuration information since the information can be set by the user as he desires if it is handled similarly to the character decoration,.

More specifically, in the above cases, it is possible to provide (produce) a detection label on which is printed a character string information image as a to-be-detected image, which represents character string information (a kind of desired configuration information) for use in printing an image (fixed-form character string image) of a fixed-form character string having at least one character arranged therein. Therefore, if a detection label of the above-mentioned kind is affixed to a tape cartridge, and the tape cartridge is mounted in a tape printing apparatus which is capable of detecting a to-be-detected image printed on the detection label, it is possible to print a fixed-form character string image based on the character string information represented by the to-be-detected image (character string information image) without newly inputting a fixed-form character string. In other words, if a detection label of the above-mentioned kind is labeled on an arbitrary tape cartridge, it is possible to cause the tape cartridge to detectably hold information of a fixed-form character string image to be printed.

It should be noted that in the above cases as well, embossed images may be employed (formed) as to-be-detected images in place of print images. Further, similarly to the above embodiment, for instance, light detection means which is capable of optically reading (detecting) an image to be detected, and detection means (embossed pattern detection means) for detecting an embossed pattern of a to-be-detected image when the to-be-detected image is an embossed image can be employed as detection means. For instance, in the former case (to-be-detected image being a fixed-form character string image printed or formed), it is possible to employ light detection means which can detect the image itself similarly to a scanner or the like. If a to-be-detected image is an embossed image formed by projections or depressions, detection means for detecting the shapes of the projections or the depressions of the image may be employed.

On the other hand, in the latter case (to-be-detected image being a designation image for designating one of registered fixed-form character string images), similarly to the above embodiment, a pattern image (e.g. a to-be-detected image formed e.g. by a bar code pattern) which is formed by patterning designation of one fixed-form character string image in a predetermined format can be employed as a to-be-detected image (designation image). In this case, as detection means maybe employed light detection means formed by a photocoupler, or if an image to be detected is an embossed image, mechanical detection means which detects an embossed pattern of the image by using detection switches of a push type which are turned on and off according to the embossed pattern may be employed as detection means.

In the above cases, if only a tape cartridge having a detection label labeled thereon is mounted in a tape printing apparatus which is capable of detecting a to-be-detected image printed on the detection label, a detected image (designation image or pattern image thereof) designates one of fixed-form character string images registered as character string information, for the tape printing apparatus, and hence the designated fixed-form character string image can be printed based on the character string information (designation).

Of course, similarly to the above-described embodiment, a pattern of a to-be-detected image can be set to a pattern representative of a code formed by encoding designation information of a fixed-form character string image, or the code may be set to a binary code. Further, if a pattern image is set to a unicolor or monochromatic pattern image representing a code of the pattern image in a single color, it is possible to form a to-be-detected image in unicolor, thereby making it possible to reduce costs for causing a tape cartridge to hold a character string information image, particularly costs for producing a detection label. Further, in this case as well, the unicolor pattern may be not only a binary code represented by the presence or absence of a single color but also a multiple-valued pattern, such as a bar code represented by the lengths and widths of bars.

In the above example, a detection label printed with a character string information image as a to-be-detected image, which represents character string information for use in printing a fixed-form character string image, is labeled to the tape cartridge. Therefore, in the above tape printing method and the tape printing apparatus, the tape cartridge is mounted, the to-be-detected image which is printed on the detection label affixed to the tape cartridge is detected, and the fixed-form character string image is printed on the tape unwound from the tape cartridge, based on the character string information represented by the to-be-detected image. That is, simply by mounting the tape cartridge in the apparatus, without newly inputting the fixed-form character string, it is possible to print the fixed-form character string image on the tape unwound or dispensed from the tape cartridge based on the character string image indicated by the to-be-detected image which is printed on the detection label affixed to the tape cartridge.

It should be noted that in the case of the to-be-detected image being a fixed-form character string image (the case of the to-be-detected image being printed as it is), it is possible to omit (dispense with) input means (keyboard, for instance) for inputting character strings and the like. Further, also when the to-be-detected image is a designation image, if a fixed-form character string image is registered (stored e.g. in the ROM for being mounted in the apparatus) in advance, the input means can be omitted (dispensed with) similarly. It goes without saying that in the above example, a label printed with the fixed-form character string image can be produced by cutting off the printed portion of the tape.

Further, there is sometimes a case in which the user desires to repeatedly print the above fixed-form messages, such as (1) “Thank you for your constant patronage.”, (2) “CONFIRMED”, (3) “FRAGILE/HANDLE WITH CARE” and the like, as fixed-form character string images, cut off portions printed with the fixed-form character string images (fixed-form messages) for producing labels, and affix the labels to desired portions (or articles for sale). In such a case, for instance, in the tape printing apparatus G1 (with almost no entry block) described above with reference to FIGS. 12A and 12B, if any of the fixed-form messages as described above is printed, and the printed tape is taken up by a reel for a large-diameter roll (or a tape cartridge containing the reel) having a diameter (e.g. 100 mm) as large as that of the tape cartridge CC having held the tape before printing, it is possible to produce labels printed with the fixed-form message simply by cutting off printed portions as required. Although in this example, reels for large-diameter rolls (or tape cartridges containing the reels) are arranged on an input side and an output side of the apparatus, even if one or both of the reels is/are of normal size (small-sized), the same effects can be obtained.

In the case of the above example, since the tape printed with a fixed-form character string image is taken up, by repeatedly carrying out printing of the fixed-form character string image and taking up a printed portion of the tape a plurality of times, it is possible to obtain a tape on which the same fixed-form character string image is printed in succession a plurality of times. In other words, simply by cutting off the fixed-form character string images one by one, it is possible to obtain a tape which makes it possible to continuously produce labels printed with the same fixed-form character string image. Further, it can be contemplated that similarly to the above, whenever the cartridge of a refillable type is refilled, an existing detection label is changed to a new one that indicates desired configuration information corresponding to the new tape, or that tapes and detection labels corresponding to the tapes are combined for sale.

Although in the respective examples described above, a detection label printed or formed with a to-be-detected image is labeled to (a surface of a casing of) a tape cartridge to thereby detectably hold the to-be-detected image (i.e. desired configuration information and character string information), this is not limitative, but not only the detection label but also a plate (detection plate) which is formed e.g. of a plastic or a cardboard similarly printed or formed with a to-be-detected image may be attached to a surface of a casing of a tape cartridge. More specifically, a to-be-detected image is detectably printed or formed on a surface of a certain member to attach the to-be-detected image to a surface of a cartridge casing, whereby it is possible to cause the tape cartridge to detectably hold the to-be-detected image (i.e. desired configuration information and character string information). Similarly, without using the member, by directly printing or forming a to-be-detected image on the surface of the cartridge casing, it is possible to cause the tape cartridge to detectably hold the desired configuration information and character string information.

It is further understood by those skilled in the art that the foregoing are preferred embodiments of the invention, and that various changes and modifications may be made without departing from the spirit and scope thereof.

What is claimed is:

1. A tape printing apparatus comprising:
first tape cartridge-mounting means for mounting a first tape cartridge accommodating a first tape;
desired configuration information input means for inputting desired configuration information; and
to-be-detected image-printing means for printing a to-be-detected image representative of said desired configuration information on said first tape such that said to-be-detected image can be detected by predetermined detection means, thereby enabling production of a detection label for being labeled on an arbitrary tape cartridge, with said to-be-detected image printed on said detection label.

2. A tape printing apparatus according to claim 1, wherein said desired configuration information contains information of designation of at least one of a typeface, a decoration, and a color, for use in printing.

3. A tape printing apparatus according to claim 1, wherein said to-be-detected image is an image of a pattern formed by patterning said desired configuration information in a predetermined format.

4. A tape printing apparatus according to claim 3, wherein said pattern represents a code formed by encoding said desired configuration information.

5. A tape printing apparatus according to claim 4, wherein said code is a binary code.

6. A tape printing apparatus according to claim 4, wherein said pattern image is a unicolor pattern image that represents said code in a single color.

7. A tape cartridge labeled with a detection label printed with a to-be-detected image representative of desired configuration information for use in printing.

8. A tape cartridge according to claim 7, wherein said detection label is formed by cutting off a first tape, the tape cartridge accommodating a second tape.

9. A tape cartridge according to claim 8, wherein said to-be-detected image is printed on said first tape by using a tape printing apparatus comprising:
first tape cartridge mounting means for mounting a first tape cartridge accommodating said first tape;
desired configuration information input means for inputting said desired configuration information; and
to-be-detected image-printing means for printing said to-be-detected image representative of said desired configuration information on said first tape such that said to-be-detected image can be detected by predetermined detection means.

10. A tape cartridge according to claim 9, which accommodates said first tape as said second tape, and can be mounted in said tape printing apparatus as said first tape cartridge.

11. A tape printing apparatus comprising:
tape cartridge-mounting means for mounting a tape cartridge labeled with a detection label formed by cutting off a first tape printed with a to-be-detected image representative of desired configuration information for use in printing;
detection means for detecting said to-be-detected image which is printed on said detection label labeled on said tape cartridge; and
image-printing means for printing an image on said second tape based on said desired configuration information represented by said to-be-detected image.

12. A tape printing apparatus according to claim 11, further including character string input means for inputting a character string having at least one character arranged therein,
wherein said desired configuration information represented by said to-be-detected image includes information concerning printing of the input character string, and
wherein said image printing means prints said print image based on the input character string according to said desired configuration information.

13. A tape printing apparatus according to claim 11, wherein said print image is an image identical to said to-be-detected image.

14. A label-producing method comprising the steps of:
mounting a first tape cartridge accommodating a first tape in a first tape printing apparatus;
inputting desired configuration information to said first tape printing apparatus;
printing a to-be-detected image representative of said desired configuration information on said first tape by using said first tape printing apparatus such that said to-be-detected image can be detected by predetermined detection means;
producing a detection label by cutting off a portion including said to-be-detected image from said first tape;
labeling said detection label on a second tape cartridge accommodating a second tape;
mounting said second tape cartridge in a second tape printing apparatus including said predetermined detection means;
detecting said to-be-detected image which is printed on said detection label labeled on said second tape cartridge, by said predetermined detection means of said second tape printing apparatus;
printing a print image on said second tape dispensed from said second tape cartridge based on said desired configuration information represented by said to-be-detected image; and
producing a print image label by cutting off a portion including said print image from said second tape.

15. A label-producing method according to claim 14, wherein said first tape printing apparatus and said second tape printing apparatus are an identical tape printing apparatus.

16. A label-producing method according to claim 14, wherein said first tape cartridge and said second tape cartridge are an identical tape cartridge.

17. A label-producing method according to claim 14, wherein said desired configuration information contains information of designation of at least one of a typeface, a decoration, and a color, for use in printing.

18. A label-producing method according to claim 14, wherein said to-be-detected image is an image of a pattern formed by patterning said desired configuration information in a predetermined format.

19. A label-producing method according to claim 18, wherein said pattern represents a code formed by encoding said desired configuration information.

20. A label-producing method according to claim 19, wherein said code is a binary code.

21. A label-producing method according to claim 19, wherein said pattern image is a unicolor pattern image that represents said code in a single color.

22. A label-producing method according to claim 14, further including the step of inputting a character string having at least one character arranged therein, to said second tape printing apparatus, and
wherein said desired configuration information represented by said to-be-detected image contains information concerning printing of the input character string, and
wherein said print image is printed according to said desired configuration information based on the input character string.

23. A label-producing method according to claim 14, wherein said image is a second to-be-detected image which is an image identical to said to-be-detected image.

24. A label-producing method according to claim 23, further comprising the steps of:
labeling a second detection label to a third tape cartridge accommodating a third tape, said second detection label being a print image label produced by cutting off a portion including said second to-be-detected image which is printed on said second tape by said second tape printing apparatus, from said second tape;
mounting said third tape cartridge in a third tape printing apparatus including said predetermined detection means;
detecting said second to-be-detected image which is printed on said second detection label labeled on said third tape cartridge, by using said predetermined detection means of said third tape printing apparatus;
printing a second print image which is different from said second to-be-detected image, on said third tape dispensed from said third tape cartridge, based on said desired configuration information represented by said second to-be-detected image; and
producing a second print image label by cutting off a portion including said second print image from said third tape.

25. A label-producing method according to claim 24, further including the step of inputting a character string having at least one character arranged therein, to said third tape printing apparatus,
wherein said desired configuration information represented by said second to-be-detected image contains information concerning printing of the input character string, and
wherein said second print image is printed according to said desired configuration information based on the input character string.

26. A label-producing method according to claim 24, wherein said second tape printing apparatus and said third tape printing apparatus are an identical printing apparatus.

27. A tape cartridge bearing a to-be-detected image in a manner such that said to-be-detected image can be detected by a predetermined detection means,
wherein said to-be-detected image is a character string information image that represents character string information for printing an image of a fixed-form character string having at least one character arranged therein.

28. A tape cartridge according to claim 27, wherein said to-be-detected image is said image of said fixed-form character string.

29. A tape cartridge according to claim 27, wherein said to-be-detected image is a designation image representative of designation of selection of one of registered fixed-form character string images.

30. A tape cartridge according to claim 29, wherein said to-be-detected image is an image of a pattern which is formed by patterning said designation in a predetermined format.

31. A tape cartridge according to claim 30, wherein said pattern represents a code formed by encoding information of said designation.

32. A tape cartridge according to claim 31, wherein said code is a binary code.

33. A tape cartridge according to claim 31, wherein said pattern image is a unicolor pattern image that represents said code in a single color.

34. A tape cartridge according to claim 27, wherein said to-be-detected image is printed or formed on a surface of a member attached to a cartridge casing.

35. A tape cartridge according to claim 34, wherein said member attached to said cartridge casing is a label affixed to a surface of said cartridge casing.

36. A tape cartridge according to claim 34, wherein said member attached to said cartridge casing is a plate attached to a surface of said cartridge casing.

37. A tape cartridge according to claim 27, wherein said to-be-detected image is an image printed or formed on a surface of said cartridge casing.

38. A tape printing apparatus comprising:
tape cartridge-mounting means for mounting a tape cartridge;
detection means for detecting a to-be-detected image that said tape cartridge bears; and
character string image-printing means for printing a fixed-form character string image on a tape dispensed from said tape cartridge, based on character string information represented by said to-be-detected image.

39. A tape printing apparatus according to claim 38, further including tape take-up means for taking up a tape printed with said fixed-form character string image.

40. A tape printing apparatus according to claim 38, further including tape cutter means for cutting off a portion printed with said fixed-form character string image from said tape.

41. A tape printing method comprising the steps of:
mounting a tape cartridge;
detecting a to-be-detected image that said tape cartridge bears; and
printing a fixed-form character string image based on character string information represented by said to-be-detected image.

42. A tape printing method according to claim 41, further including the step of taking up a tape printed with said fixed-form character string image.

43. A label-producing method comprising the steps of:
mounting a tape cartridge;
detecting a to-be-detected image that said tape cartridge bears;
printing a fixed-form character string image based on character string information represented by said to-be-detected image;
taking up a tape printed with said fixed-form character string image; and
cutting off a portion printed with said fixed-form character string image from said tape.
